(19) United States
(12) Patent Application Publication
(10) Pub. No.: US 2025/0336013 A1
(43) Pub. Date: Oct. 30, 2025

(54) TRAVEL ASSISTANCE TERMINAL

(71) Applicant: NEC Corporation, Tokyo (JP)

(72) Inventors: Manami AMMA, Tokyo (JP); Kei KANEKO, Tokyo (JP)

(73) Assignee: NEC Corporation, Tokyo (JP)

(21) Appl. No.: 19/090,630

(22) Filed: Mar. 26, 2025

(30) Foreign Application Priority Data
Apr. 30, 2024 (JP) 2024-073479

(51) Int. Cl. G06Q 50/14; G06V 20/50

(52) U.S. Cl. CPC G06Q 50/14; G06V 20/50

(57) ABSTRACT

To assist in enriching travel of a second user by using a travel history in which a first user has actually made a tour. A travel assistance terminal according the present disclosure includes: acquisition unit configured to acquire information regarding a recommended point determined based on circulation recording information including a plurality of images captured at each point by a first user and generated on the basis of an imaging order, the circulation recording information being information in which each imaging point of the images is associated with a corresponding point on a three-dimensional virtual space, and position information of a second user; and display unit configured to display a recommendation to move to the recommended point on a screen displayed from a viewpoint of the second user.

### INCORPORATION BY REFERENCE

This application is based upon and claims the benefit of priority from Japanese patent application No. 2024-073479, filed on Apr. 30, 2024, the disclosure of which is incorporated herein in its entirety by reference.

### TECHNICAL FIELD

The present disclosure relates to a travel assistance terminal, an apparatus, a system, a method, and a program.

### BACKGROUND ART

The technology disclosed in Patent Literature 1 discloses a technology related to an information processing apparatus that draws a virtual space image on the basis of a two-dimensional image. The information processing apparatus according to Japanese Unexamined Patent Application Publication No. 2024-008779 creates data of a three-dimensional virtual space including an imaging object or a landscape on the basis of two-dimensional image data that captures the imaging object or the landscape, and draws a virtual space image viewed from a virtual camera on the basis of the data of the three-dimensional virtual space.
Patent Literature 1: Japanese Unexamined Patent Application Publication No. 2024-008779

### SUMMARY

Here, there is a need to utilize a travel history actually experienced by another traveler when a scheduled traveler plans a travel.

In view of the above-described problems, an example object of the present disclosure is to provide a travel assistance terminal, an apparatus, a system, a method, and a program for assisting in enriching travel of a second user by using a travel history in which a first user has actually made a tour.

A travel assistance terminal according an example aspect of the present disclosure includes:
acquisition unit for acquiring information regarding a recommended point determined based on circulation recording information including a plurality of images captured at each point by a first user and generated on the basis of an imaging order, the circulation recording information being information in which each imaging point of the images is associated with a corresponding point on a three-dimensional virtual space, and position information of a second user; and display unit for displaying a recommendation to move to the recommended point on a screen displayed from a viewpoint of the second user.

A travel assistance apparatus according an example aspect of the present disclosure includes:
generation unit for generating circulation recording information based on an imaging order including a plurality of images captured at each point by a first user; and
registration unit for registering the circulation recording information such that the circulation recording information is available to a second user by associating each imaging point of the images included in the circulation recording information with a corresponding point on a three-dimensional virtual space.

A travel assistance terminal according an example aspect of the present disclosure includes:
acquisition unit for acquiring a plurality of images captured at each point by a first user; and
registration unit for registering circulation recording information including the plurality of images and generated on the basis of an imaging order such that the circulation recording information is available to a second user by associating each imaging point of the images with a corresponding point on a three-dimensional virtual space.

A travel assistance system according an example aspect of the present disclosure includes:
a first travel assistance terminal;
a second travel assistance terminal; and
a travel assistance apparatus, wherein
the first travel assistance terminal transmits, to the travel assistance apparatus, a plurality of images captured by a first user at each point, and
the travel assistance apparatus
generates circulation recording information based on an imaging order including the plurality of images received from the first travel assistance terminal, and
registers the circulation recording information such that the circulation recording information is available to a second user via the second travel assistance terminal by associating each imaging point of the images included in the circulation recording information with each point on a three-dimensional virtual space.

In a travel assistance method according to an example aspect the present disclosure, a computer:
acquiring information regarding a recommended point determined based on circulation recording information including a plurality of images captured at each point by a first user and generated on the basis of an imaging order, the circulation recording information being information in which each imaging point of the images is associated with a corresponding point on a three-dimensional virtual space, and position information of a second user; and
displaying a recommendation to move to the recommended point on a screen displayed from a viewpoint of the second user.

In a travel assistance method according to an example aspect the present disclosure, a computer:
generating circulation recording information based on an imaging order including a plurality of images captured at each point by a first user; and
registering the circulation recording information such that the circulation recording information is available to a second user by associating each imaging point of the images included in the circulation recording information with each point on a three-dimensional virtual space.

In a travel assistance method according to an example aspect the present disclosure, a computer:
registering circulation recording information including the plurality of images and generated on the basis of an imaging order such that the circulation recording information is available to a second user by associating each imaging point of the images with each point on a three-dimensional virtual space.

A travel assistance program according to an example aspect of the present disclosure causes a computer to perform:
an acquisition process of acquiring information regarding a recommended point determined based on circulation recording information including a plurality of images captured at each point by a first user and generated on the basis of an imaging order, the circulation recording information being information in which each imaging point of the images is associated with a corresponding point on a three-dimensional virtual space, and position information of a second user; and
a recommendation display process of displaying a recommendation to move to the recommended point on a screen displayed from a viewpoint of the second user.

A travel assistance program according to an example aspect of the present disclosure causes a computer to perform:
a generation process of generating circulation recording information based on an imaging order including a plurality of images captured at each point by a first user; and
a registration process of registering the circulation recording information such that the circulation recording information is available to a second user by associating each imaging point of the images included in the circulation recording information with each point on a three-dimensional virtual space.

A travel assistance program according to an example aspect of the present disclosure causes a computer to perform:
an acquisition process of acquiring a plurality of images captured at each point by a first user; and
a registration process of registering circulation recording information including the plurality of images and generated on the basis of an imaging order such that the circulation recording information is available to a second user by associating each imaging point of the images with each point on a three-dimensional virtual space.

An example advantage according to the above-described embodiments is to be able to assist in enriching travel of a second user by using a travel history in which a first user has actually made a tour.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing a configuration of a travel assistance terminal according to the present disclosure;

FIG. 2 is a flowchart showing a flow of a travel assistance method according to the present disclosure;

FIG. 3 is a block diagram showing a configuration of a travel assistance apparatus according to the present disclosure;

FIG. 4 is a flowchart showing a flow of a travel assistance method according to the present disclosure;

FIG. 5 is a block diagram showing a configuration of a travel assistance terminal according to the present disclosure;

FIG. 6 is a flowchart showing a flow of a travel assistance method according to the present disclosure;

FIG. 7 is a block diagram showing an overall configuration of a travel assistance system according to the present disclosure;

FIG. 8 is a block diagram showing a configuration of an information terminal according to the present disclosure;

FIG. 9 is a block diagram showing a hardware configuration of the information terminal according to the present disclosure;

FIG. 10 is a block diagram showing a configuration of a travel assistance server according to the present disclosure;

FIG. 11 is a block diagram showing a hardware configuration of the travel assistance server according to the present disclosure;

FIG. 12 is a sequence chart showing a flow of travel assistance processing at the time of registration according to the present disclosure;

FIG. 13 is a sequence chart showing a flow of travel assistance processing at the time of use according to the present disclosure;

FIG. 14 is a diagram showing a display example of recommendation display information according to the present disclosure;

FIG. 15 is a diagram showing a display example of recommendation display information according to the present disclosure;

FIG. 16 is a block diagram showing a configuration of an information terminal according to the present disclosure;

FIG. 17 is a sequence chart showing a flow of travel assistance processing at the time of registration according to the present disclosure;

FIG. 18 is a sequence chart showing a flow of travel assistance processing at the time of use according to the present disclosure; and

FIG. 19 is a sequence chart showing a flow of travel assistance processing at the time of use according to the present disclosure.

### EXAMPLE EMBODIMENTS

Hereinafter, example embodiments of the present disclosure will be described in detail with reference to the drawings. In the drawings, the same or corresponding elements are denoted by the same reference numerals, and repeated description is omitted as necessary for clarity of description.

### First Example Embodiment

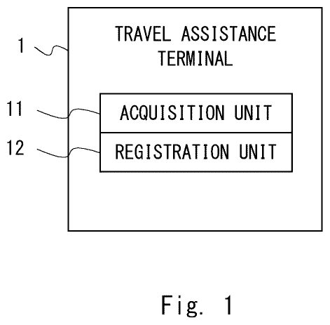

FIG. 1 is a block diagram showing a configuration of a travel assistance terminal 1. The travel assistance terminal 1 is an information processing apparatus operated by a first user and equipped with a camera. However, the travel assistance terminal 1 may be connected to an external camera without being equipped with a camera. It is assumed that the first user sequentially moves through a plurality of points and captures an image with the camera at each point. The travel assistance terminal 1 includes an acquisition unit 11 and a registration unit 12.

The acquisition unit 11 acquires a plurality of images captured at each point by the first user. The registration unit 12 registers circulation recording information by associating each imaging point of the image included in the circulation recording information with a corresponding point on a three-dimensional virtual space. Here, the “circulation recording information” is information including a plurality of images captured at each point by the first user and generated on the basis of the imaging order. Thus, the circulation recording information can also be said to be a travel history including images captured at each of a plurality of points when the first user circulated at (made a tour around) the points and the imaging order. It is assumed that each image included in the circulation recording information is associated with an imaging point where the image was captured. That is, the registration unit 12 registers the circulation recording information in association with a plurality of points on the three-dimensional virtual space. The registration unit 12 registers the circulation recording information so that a second user can use the circulation recording information. Here, the “three-dimensional virtual space” is electronic information regarding a virtual environment in which a real space is configured by three-dimensional data. The three-dimensional virtual space can be said to be a completely immersive space including a virtual environment in which a human is represented by an avatar (a character that is a virtual self of a user). The three-dimensional virtual space may be referred to as a metaverse. In the present disclosure, it is assumed that a point uniquely corresponding to a point visited by the first user in the real space is defined in advance in the three-dimensional virtual space.

Note that the second user is a user different from the first user. For example, in a case where the first user is a traveler, the second user is a scheduled traveler. The registration unit 12 may register the circulation recording information in an external database connected to the travel assistance terminal 1 via a communication network. That is, the registration unit 12 registers the circulation recording information so that the second user can access (refer to) the circulation recording information by using a predetermined information processing apparatus. As a result, the second user can access and use the circulation recording information of the first user via the communication network by using the predetermined information processing apparatus.

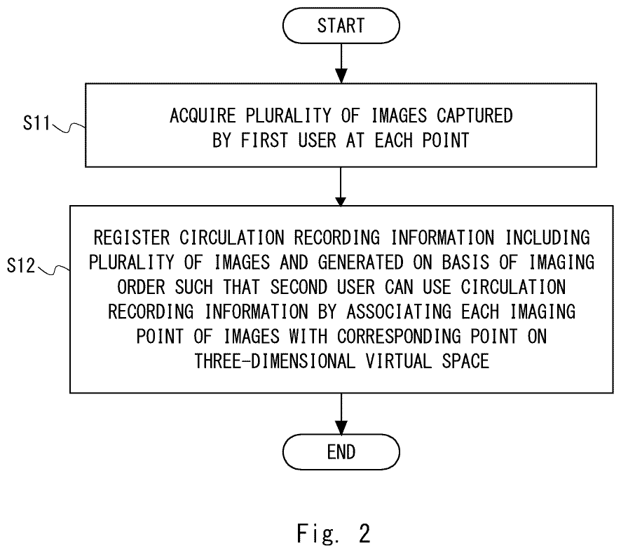

FIG. 2 is a flowchart showing a flow of a travel assistance method. First, the acquisition unit 11 acquires a plurality of images captured at each point by the first user (S11). Next, the registration unit 12 registers circulation recording information including the plurality of images and generated on the basis of the imaging order by associating each imaging point of the image with a corresponding point on the three-dimensional virtual space such that the circulation recording information is available to the second user (S12).

As described above, the circulation recording information of the present disclosure can be said to be information that defines the order of a plurality of images captured when the first user actually circulated at respective points in the real space, by regarding the imaging order derived from a difference between the imaging times and the like as the order in which the first user circulated at the respective points. Therefore, the circulation recording information can also be said to be travel recording information of the first user. In the circulation recording information, each imaging point of the image and a corresponding point on the three-dimensional virtual space are registered in association with each other. Therefore, when the second user moves on the three-dimensional virtual space by using the predetermined information processing apparatus, the images captured by the first user can be displayed at the points associated with the circulation recording information of the first user. Therefore, the second user can also simulate the travel of the first user through the three-dimensional virtual space. Therefore, the second user can make his/her travel plan with reference to the circulation recording information of the first user before or during the travel. In other words, the second user who is a scheduled traveler can utilize a travel history that another traveler (first user) has actually experienced when planning a travel. Thus, the travel assistance terminal according to the present disclosure can assist in enriching travel of the second user by using the travel history in which the first user has actually made a tour. Note that, also at a predetermined point in the real space, the second user can refer to the circulation recording information by using a predetermined information processing apparatus, and refer to an image or the like included in the circulation recording information corresponding to the point in the real space.

Note that the travel assistance terminal 1 includes a processor, a memory, and a storage device as constituents (not shown). The storage device stores, for example, a computer program in which processing of the travel assistance method in FIG. 2 is implemented. The processor reads the computer program or the like from the storage device into the memory and executes the computer program. As a result, the processor realizes the functions of the acquisition unit 11 and the registration unit 12.

Alternatively, each constituent of the travel assistance terminal 1 may be implemented by dedicated hardware. Some or all of the constituents of each apparatus may be implemented by a general-purpose or dedicated circuit, a processor, or a combination thereof. These constituents may be configured with a single chip or may be configured with a plurality of chips connected via a bus. Some or all of the constituents of each apparatus may be implemented by a combination of the above circuit or the like and a program. As the processor, a central processing unit (CPU), a graphics processing unit (GPU), a field-programmable gate array (FPGA), a quantum processor (quantum computer control chip), or the like may be used.

In a case where some or all of the constituents of the travel assistance terminal 1 are implemented by a plurality of information processing apparatuses, circuits, and the like, the plurality of information processing apparatuses, circuits, and the like may be disposed in a centralized manner or in a distributed manner. For example, the information processing apparatuses, the circuits, or the like may be implemented in the form of a client server system, a cloud computing system, or the like in which they are connected to each other via a communication network. The function of the travel assistance terminal 1 may be provided in software as a service (Saas) format.

### Second Example Embodiment

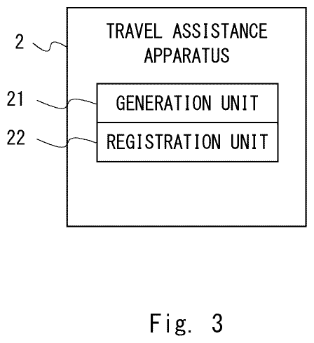

FIG. 3 is a block diagram showing a configuration of a travel assistance apparatus 2. The travel assistance apparatus 2 is an information processing apparatus for sharing information regarding a travel history in which a first user has actually made a tour with a second user. The travel assistance apparatus 2 includes a generation unit 21 and a registration unit 22.

The generation unit 21 generates circulation recording information including a plurality of images captured at each point by the first user on the basis of the imaging order. So, that, the generation unit 21 generates circulation recording information based on an imaging order including a plurality of images captured at each point by a first user. The registration unit 22 associates each imaging point of the images included in the circulation recording information with a corresponding point on a three-dimensional virtual space, and registers the circulation recording information so that the second user can use the information. Note that the circulation recording information, the three-dimensional virtual space, the first user, and the second user are similar to those in the first example embodiment described above.

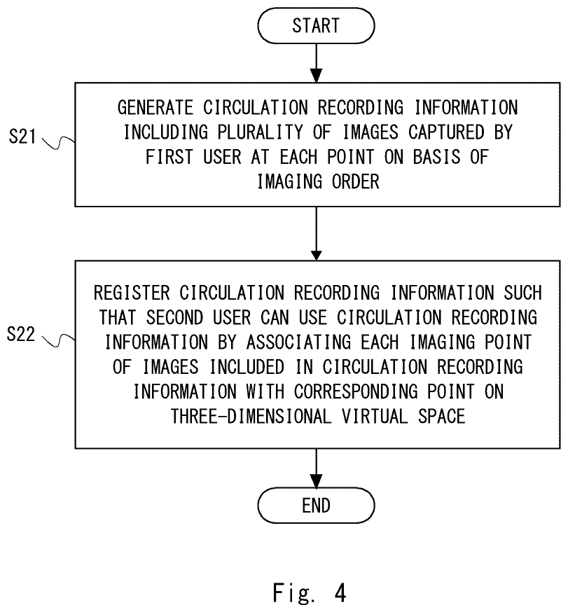

FIG. 4 is a flowchart showing a flow of a travel assistance method. First, the generation unit 21 generates circulation recording information including a plurality of images captured at each point by the first user on the basis of the imaging order (S21). Next, the registration unit 22 registers the circulation recording information such that the second user can use the circulation recording information by associating each imaging point of the image included in the circulation recording information with a corresponding point on the three-dimensional virtual space (S22).

As described above, the second example embodiment can achieve the same effects as those of the first example embodiment described above.

Note that the travel assistance apparatus 2 includes a processor, a memory, and a storage device as constituents (not shown). The storage device stores a computer program in which processing of the travel assistance method in FIG. 4 is implemented, for example. The processor reads the computer program or the like from the storage device into the memory and executes the computer program. As a result, the processor realizes the functions of the generation unit 21 and the registration unit 22.

Alternatively, each constituent of the travel assistance apparatus 2 may be implemented by dedicated hardware. Some or all of the constituents of each apparatus may be implemented by a general-purpose or dedicated circuit, a processor, or a combination thereof. These constituents may be configured with a single chip or may be configured with a plurality of chips connected via a bus. Some or all of the constituents of each apparatus may be implemented by a combination of the above circuit or the like and a program. As the processor, a central processing unit (CPU), a graphics processing unit (GPU), a field-programmable gate array (FPGA), a quantum processor (quantum computer control chip), or the like may be used.

In a case where some or all of the constituents of the travel assistance apparatus 2 are implemented by a plurality of information processing apparatuses, circuits, and the like, the plurality of information processing apparatuses, circuits, and the like may be disposed in a centralized manner or in a distributed manner. For example, the information processing apparatuses, the circuits, or the like may be implemented in the form of a client server system, a cloud computing system, or the like in which they are connected to each other via a communication network. The function of the travel assistance apparatus 2 may be provided in a software as a service (SaaS) format.

### Third Example Embodiment

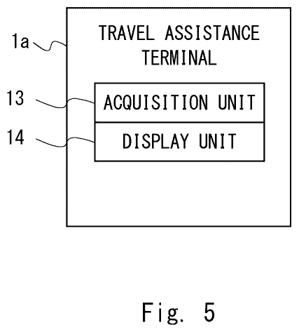

FIG. 5 is a block diagram showing a configuration of a travel assistance terminal 1a. The travel assistance terminal 1a is an information processing apparatus having a screen operated by a second user and displayed from the viewpoint of the second user. However, the travel assistance terminal 1a may have no screen and be connected to an external screen. The travel assistance terminal 1a includes an acquisition unit 13 and a display unit 14.

The acquisition unit 13 acquires information regarding a recommended point. Here, the “recommended point” is a point that is determined on the basis of circulation recording information and position information of a second user and is used for recommending movement to the second user. The “information regarding the recommended point” may be information itself indicating the recommended point, display information for recommending movement to the recommended point, text information for explaining the recommended point, or the like. The “circulation recording information” is circulation recording information including a plurality of images captured at each point by the first user and generated on the basis of the imaging order. The circulation recording information is information in which each imaging point of the image is associated with a corresponding point on the three-dimensional virtual space. For example, the acquisition unit 13 may acquire the circulation recording information of the first user from the external database via the communication network as described above in the first example embodiment. Note that the circulation recording information, the three-dimensional virtual space, the first user, and the second user are similar to those in the first example embodiment described above. The “position information of the second user” is information indicating a position where the second user currently stays, that is, information indicating a current point of the second user. Here, the “position information of the second user” may be either a current point of the second user in the three-dimensional virtual space or a current point of the second user in the real space (for example, position information of the travel assistance terminal 1a). The recommended point is a destination point to which the second user is recommended to move from the current point. Note that, in a case where the second user is using a three-dimensional virtual space, the current point and the recommended point of the second user are preferably points in the three-dimensional virtual space. Alternatively, in a case where the second user is using an augmented reality (AR) space by using the travel assistance terminal 1a in the real space, the current point and the recommended point of the second user are preferably points in the real space.

The display unit 14 displays a recommendation to move to the recommended point on a screen displayed from a viewpoint of the second user.

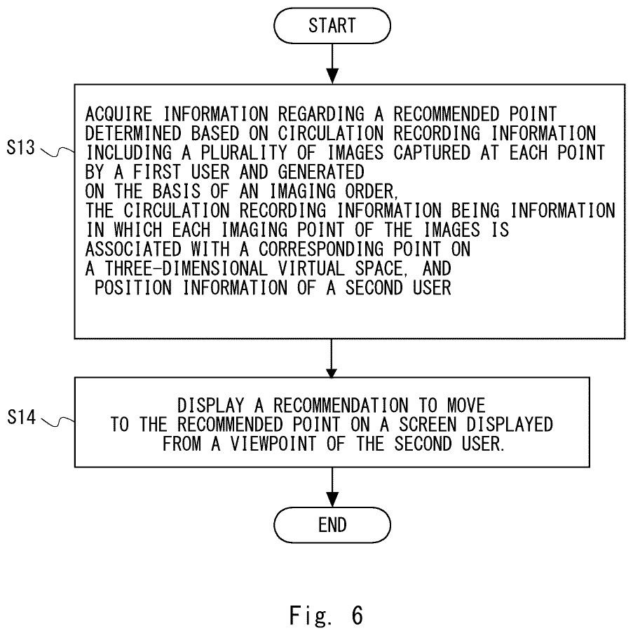

FIG. 6 is a flowchart showing a flow of a travel assistance method. First, the acquisition unit 13 acquires information regarding a recommended point determined on the basis of the circulation recording information and the position information of the second user (S13). The circulation recording information is information including a plurality of images captured at each point by the first user and generated on the basis of the imaging order. The circulation recording information is information in which each imaging point of the image is associated with a corresponding point on the three-dimensional virtual space. Next, the display unit 14 displays the screen displayed from the viewpoint of the second user such that the second user is recommended to move to the recommended point (S14).

For example, when the second user visits a point included in the circulation recording information in either the three-dimensional virtual space or the real space, a next visit place determined on the basis of the corresponding point in the circulation recording information is recommended. Specifically, it is assumed that the second user moves on the three-dimensional virtual space by using the travel assistance terminal 1a before travel (or during travel). At that time, the travel assistance terminal 1a acquires information regarding a recommended point determined on the basis of the circulation recording information of the first user and the current position information of the second user in the three-dimensional virtual space (for example, by using the travel assistance apparatus 2 of the second example embodiment described above). The travel assistance terminal 1a displays a screen on which the three-dimensional virtual space is displayed from the viewpoint of the second user such that the second user is recommended to move from the current point on the three-dimensional virtual space to the recommended point. Alternatively, the second user may use the function of the augmented reality space by using the travel assistance terminal 1a during travel. In this case, the travel assistance terminal 1a acquires information regarding a recommended point determined on the basis of the circulation recording information of the first user and the current position information of the second user in the real space. The travel assistance terminal 1a displays the captured image to recommend the second user to move from the current point in the real space to the recommended point. The third example embodiment can achieve the same effects as those of the first or second example embodiment described above.

Note that the travel assistance terminal 1a includes a processor, a memory, and a storage device as constituents (not shown). The storage device stores a computer program in which processing of the travel assistance method in FIG. 6 is implemented, for example. The processor reads the computer program or the like from the storage device into the memory and executes the computer program. As a result, the processor realizes the functions of the acquisition unit 13 and the display unit 14.

Alternatively, each constituent of the travel assistance terminal 1a may be implemented by dedicated hardware. Some or all of the constituents of each apparatus may be implemented by a general-purpose or dedicated circuit, a processor, or a combination thereof. These constituents may be configured with a single chip or may be configured with a plurality of chips connected via a bus. Some or all of the constituents of each apparatus may be implemented by a combination of the above circuit or the like and a program. As the processor, a central processing unit (CPU), a graphics processing unit (GPU), a field-programmable gate array (FPGA), a quantum processor (quantum computer control chip), or the like may be used.

In a case where some or all of the constituents of the travel assistance terminal 1a are implemented by a plurality of information processing apparatuses, circuits, and the like, the plurality of information processing apparatuses, circuits, and the like may be disposed in a centralized manner or in a distributed manner. For example, the information processing apparatuses, the circuits, or the like may be implemented in the form of a client server system, a cloud computing system, or the like in which they are connected to each other via a communication network. The function of the travel assistance terminal 1a may be provided in a software as a service (SaaS) format.

### Fourth Example Embodiment

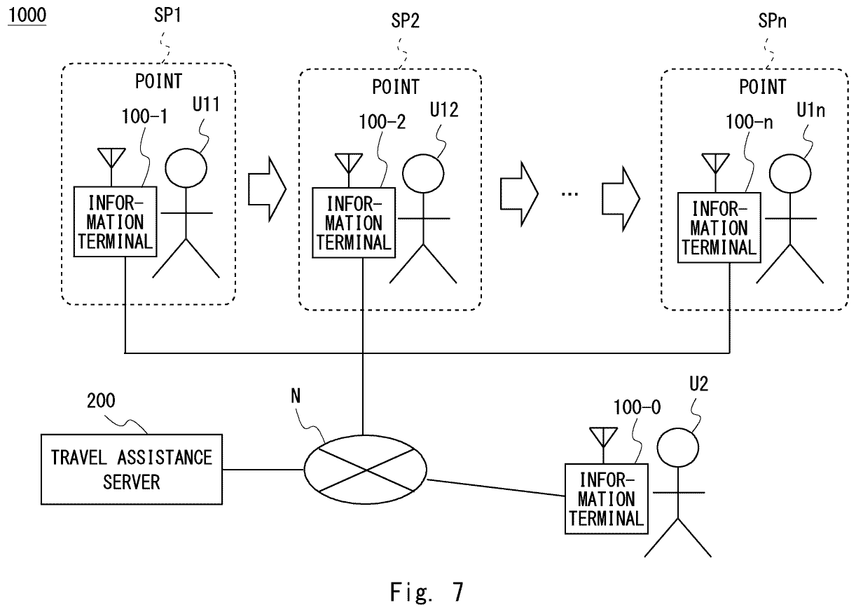

FIG. 7 is a block diagram showing an overall configuration of a travel assistance system 1000. The travel assistance system 1000 is an information system that generates and registers a travel history (circulation recording information) at points SP1 to SPn (where n is a natural number of 2 or more) where a first user U1 has actually made a tour, and shares the travel history with a second user U2. The travel assistance system 1000 includes a plurality of information terminals 100 and the like and a travel assistance server 200. The plurality of information terminals 100 and the like and the travel assistance server 200 are communicatively connected to each other via a network N. Here, the network N is a wired and wireless communication line network. The plurality of information terminals 100 and the like include, for example, an information terminal 100-1 operated by a user U11, an information terminal 100-2 operated by a user U12, . . . , an information terminal 100-n operated by a user U1n, and an information terminal 100-0 operated by a user U2. Note that, in the following description, the information terminals 100-1 to 100-n and 100-0 may be simply referred to as “information terminals 100”.

The points SP1 to SPn are included in points in the real space targeted by the travel assistance system 1000 at least in the three-dimensional virtual space. The points SP1 to SPn are, for example, tourist spots. Note that each of the users U11, U12, . . . , and U1n is the user U1 staying at each of the points SP1, SP2, . . . , and SPn. Therefore, in the following description, the users U11, U12, . . . , and U1n may be simply referred to as “user U1”. That is, the information terminal 100-1 is a terminal operated by the user U11 staying at the point SP1. The information terminal 100-2 is a terminal operated by the user U12 staying at the point SP2. Thereafter, similarly, the information terminal 100-n is a terminal operated by the user U1n staying at the point SPn.

The information terminal 100-0 is a terminal operated by the user U2 staying at a place other than the points SP1 to SPn. In the example in FIG. 7, it can be said that the user U1 is a traveler and the user U2 is a scheduled traveler.

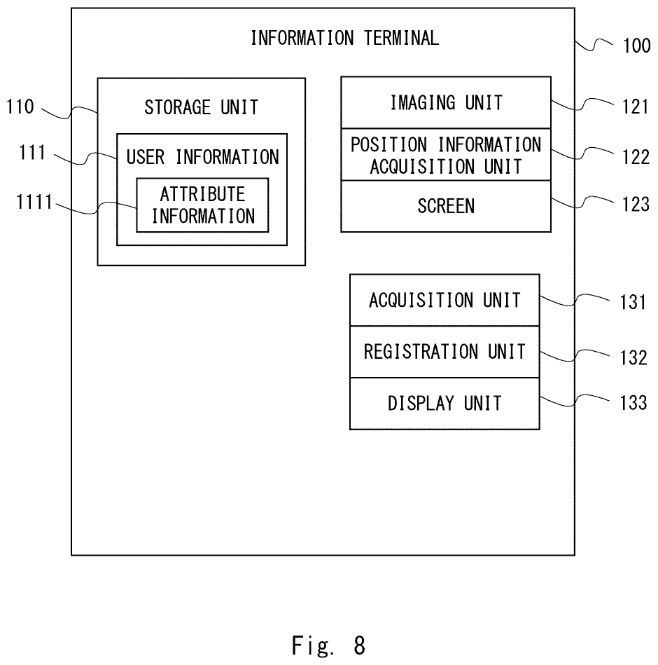

FIG. 8 is a block diagram showing a configuration of the information terminal 100. The information terminal 100 is a portable information processing apparatus having a camera function and capable of wireless communication. The information terminal 100 may be, for example, a smartphone or a tablet terminal. The information terminal 100 is an example of the travel assistance terminals 1 and 1a described above. The information terminal 100 includes a storage unit 110, an imaging unit 121, a position information acquisition unit 122, a screen 123, an acquisition unit 131, a registration unit 132, and a display unit 133.

The storage unit 110 includes, for example, a nonvolatile storage device such as a flash memory and a memory such as a random access memory (RAM), that is, a volatile storage device. The storage unit 110 stores at least user information 111. The user information 111 is information regarding a user registered in advance as a possessor (main operator). The user information 111 includes at least attribute information 1111. The attribute information 1111 includes age information of the user himself/herself, personal information such as a gender, interest information such as a hobby or a taste, a family structure, and the like. The family structure includes relationship property (a relationship or the like) between the user and the family, attribute information of each family member, the number of family members, and the like. Note that the attribute information 1111 is not limited thereto.

The imaging unit 121 includes a camera that performs imaging according to a user's operation, and a circuit, software, or the like that controls the camera.

The position information acquisition unit 122 acquires current position information of the information terminal 100 by using the wireless communication function, and records the acquired position information and an acquisition time in the storage unit 110 in association with each other. The position information acquisition unit 122 includes an apparatus that acquires current position information of the information terminal 100, and a circuit, software, or the like that controls the apparatus. The position information acquisition unit 122 acquires position information periodically or due to a predetermined trigger. Examples of the position information include, but are not limited to, global positioning system (GPS) information.

The screen 123 is a display apparatus that displays an image captured by the imaging unit 121 and various types of display information. The screen 123 is an example of a screen displayed from the viewpoint of the user.

The acquisition unit 131 is an example of the acquisition unit 11 and the acquisition unit 13 described above. The acquisition unit 131 acquires a plurality of images captured at each point by the imaging unit 121 according to the user's operation. The acquisition unit 131 also acquires travel recording information (circulation recording information) from the travel assistance server 200. The acquisition unit 131 acquires information regarding a recommended point determined on the basis of the travel recording information and the position information of the user. For example, the acquisition unit 131 acquires recommendation display information as information regarding a recommended point. The recommendation display information is display information for recommending movement to a recommended point. The recommendation display information is, for example, an arrow from the current position of an avatar corresponding to the user toward the recommended point, or text information for explaining the recommended point. However, the recommendation display information is not limited thereto.

The registration unit 132 is an example of the registration unit 12 described above. In order to generate and register travel recording information, the registration unit 132 transmits an image captured at each point, an imaging time, position information, and the like to the travel assistance server 200. The registration unit 132 may transmit a registration request for the travel recording information to the travel assistance server 200. In this case, the registration request for the travel recording information may include an image captured by the imaging unit 121 at each point, an imaging time, position information, and the like. The registration unit 132 may transmit, to the travel assistance server 200, an additional registration request for registering a user who is a sharing destination in the travel recording information.

The display unit 133 is an example of the display unit 14 described above. The display unit 133 displays the screen 123 to recommend movement to the recommended point. The display unit 133 may display information regarding the recommended point on the screen 123. The display unit 133 displays the recommendation display information on the screen 123. For example, when the information terminal 100 uses the three-dimensional virtual space, the display unit 133 displays a viewing region from the viewpoint of the user in the three-dimensional virtual space on the screen 123. The display unit 133 displays display information including an avatar corresponding to the user in the three-dimensional virtual space on the screen 123. The display unit 133 may display the recommendation display information on the screen 123 together with the avatar in the viewing region from the viewpoint of the user in the three-dimensional virtual space.

When the user U2 visits the first point included in the travel recording information of the user U1, the display unit 133 may display the recommendation display information by using the second point visited next after the first point by the user U1 as a recommended point on the basis of the imaging order in the travel recording information. As a result, the user U2 can recognize the order of the points around which the user U1 has actually made a tour. The user U2 can virtually experience a route of the points around which the user U1 has actually made a tour on the three-dimensional virtual space.

Alternatively, the display unit 133 may display the recommendation display information by using a point determined from the travel recording information as a recommended point, on the basis of time information (set time) when the user U2 visits the first point included in the travel recording information, and an imaging time by the user U1 at the first point. As a result, the user U2 sets a time to visit a certain point on the three-dimensional virtual space during travel planning and can thus ascertain a point visited by the user U1 at a time close to the set time. Therefore, a local situation can be virtually experienced with reality on the three-dimensional virtual space.

The display unit 133 may display the recommendation display information on the basis of a similarity between the attribute information of the user U1 and the attribute information of the user U2 and the travel recording information of the user U1. As a result, the user U2 can receive a recommendation for a recommended point in a recommendation manner that matches his/her needs. The display unit 133 may display pieces of recommendation display information at a plurality of recommended points in different display forms according to a similarity between each piece of attribute information included in the travel recording information of the plurality of users U1 and the attribute information of the user U2. As a result, the user U2 can easily ascertain a difference in the degree of recommendation for a plurality of recommended points according to the similarity in attribute with each of a plurality of travel experienced people.

The display unit 133 may display recommendation display information at a plurality of recommended points based on travel recording information of a plurality of users U1 on the screen 123. As a result, the user U2 can easily ascertain a point or a travel route visited by each of the plurality of travel experienced people. Thus, it is possible to assist the user U2 in independently planning a travel.

The display unit 133 may display the recommendation display information at each of a plurality of recommended points in different display forms according to an evaluation by the user U1 who has visited each of the plurality of recommended points. Note that a display form of the recommendation display information may be expressed by, for example, a color, a size, a degree of blinking, blurring, or the like of an arrow or display text. For example, the display unit 133 may display the recommendation display information in a display form such that a size of the recommendation display information increases as the evaluation becomes higher and decreases as the evaluation becomes lower. Alternatively, the display unit 133 may display the recommendation display information in a display form such that a color of the recommendation display information becomes more conspicuous as the evaluation becomes higher and less conspicuous as the evaluation becomes lower. Alternatively, the display unit 133 may display the recommendation display information in a display form such that the recommendation display information flashes as the evaluation becomes higher and blurs as the evaluation becomes lower. The display unit 133 may display the recommendation display information at each recommended point in a different display form according to the number of users who have actually visited and evaluated each recommended point. For example, the display unit 133 may display the recommendation display information (for example, an arrow) in a display form such that a size of the recommendation display information increases as the number of evaluated users increases and decreases as the number of evaluated users decreases. Alternatively, the display unit 133 may display the recommendation display information (for example, an arrow) in a display form such that a color of the recommendation display information becomes more conspicuous as the number of evaluated users increases and less conspicuous as the number of evaluated users decreases. Alternatively, the display unit 133 may display the recommendation display information (for example, an arrow) in a display form such that the recommendation display information flashes as the number of evaluated users increases and blurs as the number of evaluated users decreases. As a result, the user U2 can easily ascertain the difference in the evaluation of an actual visitor (user U1) for each recommended point. Therefore, the recommendation display information can be used as a reference when the user U2 makes a travel plan.

The display unit 133 may display pieces of recommendation display information at respective recommended points in different display forms according to the cost related to each recommended point. For example, the display unit 133 may display the recommendation display information in a display form such that a size of the recommendation display information increases as the cost increases and decreases as the cost decreases. Alternatively, the display unit 133 may display the recommendation display information in a display form such that a color of the recommendation display information becomes more conspicuous as the cost increases and less conspicuous as the cost decreases. Alternatively, the display unit 133 may display the recommendation display information in a display form such that the recommendation display information blinks as the cost increases and blurs as the cost decreases. As a result, the user U2 can easily visually ascertain the cost required for each recommended point. Therefore, the recommendation display information can be used as a reference when the user U2 makes a travel plan.

The display unit 133 may display a recommendation to move to the recommended point on the screen 123 displaying the three-dimensional virtual space. Note that the three-dimensional virtual space can be used by the user U2 via the information terminal 100.

Note that the information terminal 100 may acquire images captured by the user U2 at each point during travel, and cause the travel assistance server 200 to generate travel recording information. In this case, the information terminal 100 may register travel recording information of the user U2 in the travel assistance server 200 so that the user U1 or a third user can use the travel recording information.

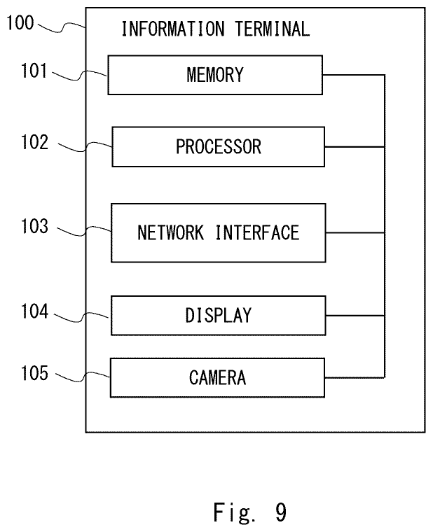

FIG. 9 is a block diagram showing a hardware configuration of the information terminal 100. The information terminal 100 includes a memory 101, a processor 102, a network interface 103, a display 104, and a camera 105.

The memory 101 is configured by a combination of a volatile memory and a nonvolatile memory. The volatile memory is, for example, a volatile storage device such as a RAM, and is a storage area for temporarily storing information during an operation of the processor 102. The nonvolatile memory is, for example, a nonvolatile storage device such as a hard disk or a flash memory. The memory 101 stores at least a computer program in which processing of a travel assistance method in the information terminal 100 according to the present disclosure is implemented. The memory 101 may include a storage disposed away from the processor 102. In this case, the processor 102 may access the memory 101 through an input/output (I/O) interface (not shown).

The processor 102 is a control apparatus that controls each constituent of the information terminal 100. The processor 102 reads and executes software (computer program) from the memory 101. Thus, the processor 102 realizes the functions of the acquisition unit 131, the registration unit 132, and the display unit 133. That is, the processor 102 performs processing of the travel assistance method in the information terminal 100 according to the present disclosure. The processor 102 may be, for example, a microprocessor, a multi processing unit (MPU), or a central processing unit (CPU). The processor 102 may include a plurality of processors.

The network interface 103 may be used to communicate with network nodes. The network interface 103 may include, for example, a network interface card (NIC) conforming to IEEE 802.3 series. IEEE represents Institute of Electrical and Electronics Engineers. The network interface 103 may include a wireless local area network (LAN), a wired LAN, Wi-Fi (registered trademark), Bluetooth (registered trademark), and the like. The network interface 103 may have a function of acquiring position information. The network interface 103 acquires, for example, global positioning system (GPS) information as current position information of the information terminal 100.

The display 104 is a display apparatus that displays information for which an instruction is given from the processor 102. The display 104 is, for example, a screen such as a liquid crystal display or an organic electro-luminescence (EL) display. Note that the display 104 may include a touch panel. That is, the display 104 may be an input/output apparatus from/to a user.

The camera 105 captures an image in response to an instruction from the processor 102, and outputs the captured image to the processor 102. The camera 105 is, for example, a charge coupled device (CCD) image sensor or a complementary metal oxide semiconductor (CMOS) sensor. The camera 105 is one or more imaging apparatuses.

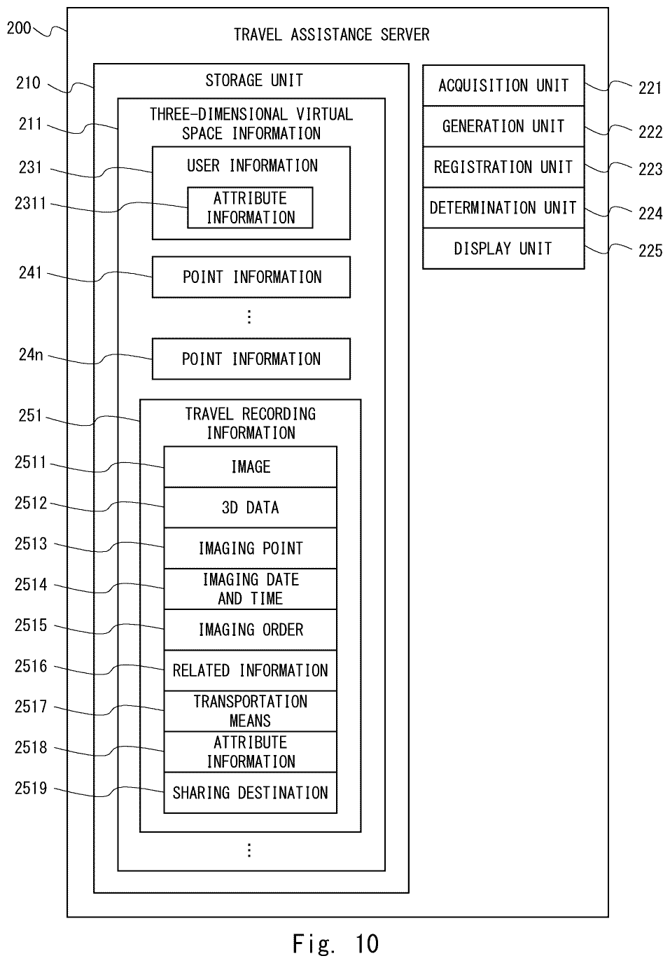

FIG. 10 is a block diagram showing a configuration of a travel assistance server 200. The travel assistance server 200 is an example of the travel assistance apparatus 2 described above. For example, the travel assistance server 200 receives an image captured at each point or the like from the information terminal 100 of the user U1, and generates travel recording information of the user U1 including a plurality of received images and the like on the basis of the imaging order. The travel assistance server 200 registers the travel recording information such that the user U2 can use the travel recording information with the information terminal 100-0 by associating each imaging point of the image included in the travel recording information with a corresponding point on the three-dimensional virtual space. When the information terminal 100-0 of the user U2 uses the three-dimensional virtual space, the travel assistance server 200 determines a recommended point on the basis of the travel recording information of the user U1 and the position information of the user U2, transmits information regarding the recommended point to the information terminal 100-0, and displays the information on the screen. The travel assistance server 200 includes a storage unit 210, an acquisition unit 221, a generation unit 222, a registration unit 223, a determination unit 224, and a display unit 225.

The storage unit 210 includes, for example, a nonvolatile storage device such as a hard disk or a flash memory, and a memory such as a random access memory (RAM), that is, a volatile storage device. The storage unit 210 stores at least three-dimensional virtual space information 211. The three-dimensional virtual space information 211 stores user information 231, pieces of point information 241 to 24n, and one or more pieces of travel recording information 251. The user information 231 is information regarding a user registered to use the three-dimensional virtual space configured in the three-dimensional virtual space information 211. The user information 231 includes at least attribute information 2311. Note that the user information 231 and the attribute information 2311 are information equivalent to the user information 111 and the attribute information 1111 described above. The user information 231 is user information of a plurality of persons including the users U1 and U2.

The pieces of point information 241 to 24n are information defining points including position information of the points SP1 to SPn in FIG. 7. The point information 241 and the like include position information in the three-dimensional virtual space. That is, the point information 241 and the like are information in which position information in the real space and position information in the three-dimensional virtual space are associated with each other. The point information 241 and the like may include store information and related information regarding a tourist spot in the point. The store information may include a name of a store, a genre, business hours, the number of occupants, a price range, and the like.

The travel recording information 251 is an example of the above circulation recording information. The travel recording information 251 is electronic data of a travel record when a certain user made a tour around a plurality of points. The travel recording information 251 is information in which an image 2511, 3D data 2512, an imaging point 2513, imaging date and time 2514, an imaging order 2515, related information 2516, transportation means 2517, attribute information 2518, and a sharing destination 2519 are associated with each other. However, the information included in the travel recording information 251 is merely an example. Note that travel recording information 251 includes information in which two or more images 2511, (3D data 2512,) the imaging point 2513, the imaging date and time 2514, and the related information 2516 are associated per record (a travel record of one user). Two or more images 2511 may be associated with one imaging point 2513.

The image 2511 is image data directly captured by a user who is a traveler at a site that is a predetermined point. The 3D data 2512 is data 3D scanned from the image 2511. The imaging point 2513 is any of the pieces of point information 241 to 24n including position information of a point where the image 2511 is captured. The imaging date and time 2514 are time information at which the image 2511 is captured. The imaging order 2515 is an imaging order of the plurality of images 2511 in one record of the travel recording information 251. Thus, the imaging order 2515 may be derived from the order of a plurality of imaging dates and times 2514 in one record. In a case where the imaging order 2515 is dynamically derived from the order of the plurality of imaging dates and times 2514, the imaging order need not be stored in the storage unit 210. The related information 2516 is information related to the corresponding imaging point 2513. For example, the related information 2516 may include the point information 241 and the like (objective information) corresponding to the imaging point 2513, a comment of a user who has performed imaging at the imaging point 2513, and the like (an impression, the degree of entry, and subjective information). The transportation means 2517 is means used when the user moved between the imaging points. Therefore, the transportation means 2517 may include different transportation means between a plurality of points. The transportation means 2517 is, for example, walking, a taxi, or public transportation. The attribute information 2518 is user attribute information corresponding to one record of the travel recording information 251. The sharing destination 2519 is user information (for example, a user ID) shared for one record of the travel recording information 251. A user set as the sharing destination 2519 can use (access) the travel recording information 251. Alternatively, the sharing destination 2519 may be all registered users in the three-dimensional virtual space. This indicates that the travel recording information 251 of a certain user has been published.

The acquisition unit 221 acquires an image or the like by receiving the image or the like captured at each point from the information terminal 100 of the user U1. The acquisition unit 221 acquires a user who is a sharing destination by receiving the user who is the sharing destination of the travel recording information from the information terminal 100 of the user U1. When the user U2 uses the three-dimensional virtual space, the acquisition unit 221 acquires user information and position information of the user U2 by receiving the user information and the position information from the information terminal 100-0.

The generation unit 222 is an example of the generation unit 21 described above. The generation unit 222 generates travel recording information of the user U1 including the plurality of received images and the like on the basis of the imaging order. The generation unit 222 may generate the travel recording information including an imaging time of each of the plurality of images. The generation unit 222 may generate the travel recording information including the attribute information of the user U1. The generation unit 222 may generate the travel recording information including transportation means between the imaging points estimated on the basis of a distance between the imaging points in the respective images and a difference between imaging dates and times of the respective images. Therefore, the generation unit 222 may estimate the transportation means between the imaging points on the basis of the distance between the imaging points in the respective images and the difference between the imaging dates and times of the respective image.

The registration unit 223 is an example of the registration unit 22 described above. The registration unit 223 registers the travel recording information so that the second user can use the travel recording information by associating each imaging point of the image included in the travel recording information with a corresponding point on the three-dimensional virtual space. Specifically, the registration unit 223 specifies point information including the imaging point acquired together with the image from the information terminal 100 among the pieces of point information 241 to 24n. The registration unit 223 causes the specified point information to be included in the travel recording information 251 as the imaging point 2513. This processing can be said to be processing in which “the registration unit 223 registers the travel recording information by associating each imaging point of the image included in the travel recording information with a corresponding point on the three-dimensional virtual space”. The registration unit 223 sets the information of the user U2 designated by the user U1 as the sharing destination 2519, thereby registering the travel recording information so that the user U2 can use the travel recording information on the three-dimensional virtual space.

The determination unit 224 may determine a recommended point to the user U2 on the basis of the travel recording information of the user U1 and the position information of the user U2. Specifically, the determination unit 224 specifies an imaging point (first point) in the travel recording information of the user U1 including the position information of the user U2, and determines, as a recommended point, an imaging point (second point) that the user U1 visits next after the first point in the travel recording information of the user U1.

Alternatively, the determination unit 224 determines a recommended point from the travel recording information on the basis of time information when the user U2 visited the first point included in the travel recording information, and an imaging time at which the user U1 captured an image at the first point. For example, it is assumed that the user U2 sets a time to visit a certain point on the three-dimensional virtual space during travel planning. In a case where a point visited by the user U2 on the three-dimensional virtual space is the first point, the determination unit 224 preferably sets, as a recommended point, a point at which the user U1 performed imaging at the set time or slightly after the set time.

The determination unit 224 may determine a recommended point on the basis of a similarity between the attribute information of the user U1 and the attribute information of the user U2 and the travel recording information of the user U1. The determination unit 224 may determine a plurality of recommended points according to a similarity between each piece of attribute information included in pieces of travel recording information of a plurality of users U1 and the attribute information of the user U2.

The determination unit 224 may determine a recommended point according to an evaluation of a user who visited each of the points SP1 to SPn. The determination unit 224 may determine a recommended point according to the cost associated with each of the points SP1 to SPn.

The determination unit 224 determines recommendation display information for recommending movement to a recommended point based on the circulation recording information. Specifically, the determination unit 224 may determine the recommendation display information on the basis of the related information of the recommended point, the attribute information of the users U1 and U2, the set time, and the like. The determination unit 224 may determine the recommendation display information to be displayed in different display forms on the basis of the related information of the recommended point, the attribute information of the users U1 and U2, the set time, and the like. The display form is, for example, visual information such as a color, a size, and decoration. In particular, the determination unit 224 may determine recommendation display information at a plurality of recommended points in different display forms according to a similarity between each piece of attribute information included in pieces of travel recording information of the plurality of users U1 and the attribute information of the user U2. The determination unit 224 may determine recommendation display information at a plurality of recommended points in different display forms according to an evaluation of the user U1 who visited each of the plurality of recommended points. The determination unit 224 may determine recommendation display information at respective recommended points in different display forms according to the cost related to each recommended point.

The display unit 225 displays recommendation display information for recommending movement to a recommended point based on the travel recording information on a screen displayed from the viewpoint of the user U2. Specifically, the display unit 225 displays the recommendation display information on the screen of the information terminal 100-0 by transmitting the recommendation display information determined by the determination unit 224 to the information terminal 100-0 of the user U2. In particular, the display unit 225 may display the recommendation display information at the recommended point on the screen displaying the three-dimensional virtual space used by the user U2. The display unit 225 displays the recommendation display information at the recommended point determined by the determination unit 224.

The display unit 225 may display recommendation display information at a plurality of recommended points in different display forms according to a similarity between each piece of attribute information included in the pieces of travel recording information of the plurality of users U1 and the attribute information of the user U2.

The display unit 225 may display recommendation display information at a plurality of recommended points on the screen of the information terminal 100-0 of the user U2 on the basis of the pieces of travel recording information of the plurality of users U1.

The display unit 225 may display recommendation display information at respective recommended points in different display forms according to the evaluation of a user who visited each of the points SP1 to SPn. The display unit 225 may display recommendation display information at respective recommended points in different display forms according to the cost related to each of the points SP1 to SPn.

The determination unit 224 determines recommendation display information for recommending movement to a recommended point based on the circulation recording information. Specifically, the determination unit 224 may determine the recommendation display information on the basis of the related information of the recommended point, the attribute information of the users U1 and U2, the set time, and the like. In particular, the determination unit 224 may determine recommendation display information at a plurality of recommended points in different display forms according to a similarity between each piece of attribute information included in pieces of travel recording information of the plurality of users U1 and the attribute information of the user U2. The determination unit 224 may determine recommendation display information at a plurality of recommended points in different display forms according to an evaluation of the user U1 who visited each of the plurality of recommended points. The determination unit 224 may determine recommendation display information at respective recommended points in different display forms according to the cost related to each recommended point.

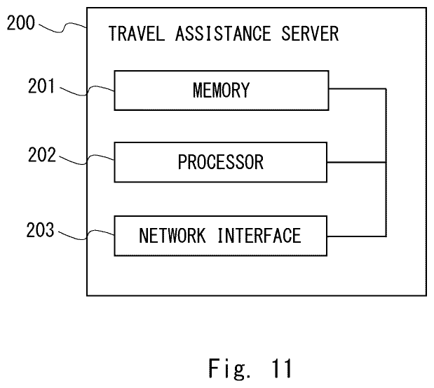

FIG. 11 is a block diagram showing a hardware configuration of the travel assistance server 200. The travel assistance server 200 includes a memory 201, a processor 202, and a network interface 203.

The memory 201 stores at least a computer program in which processing of a travel assistance method in the travel assistance server 200 according to the present disclosure is implemented. Other configurations of the memory 201 are similar to those of the memory 101. The processor 202 is a control apparatus that controls each constituent of the travel assistance server 200. The processor 202 reads software (computer program) from the memory 201 and executes the software. As a result, the processor 202 realizes the functions of the acquisition unit 221, the generation unit 222, the registration unit 223, the determination unit 224, and the display unit 225. That is, the processor 202 performs processing of a travel assistance method in the travel assistance server 200 according to the present disclosure. Other configurations of the processor 202 are similar to those of the processor 102. The network interface 203 has a configuration similar to that of the network interface 103.

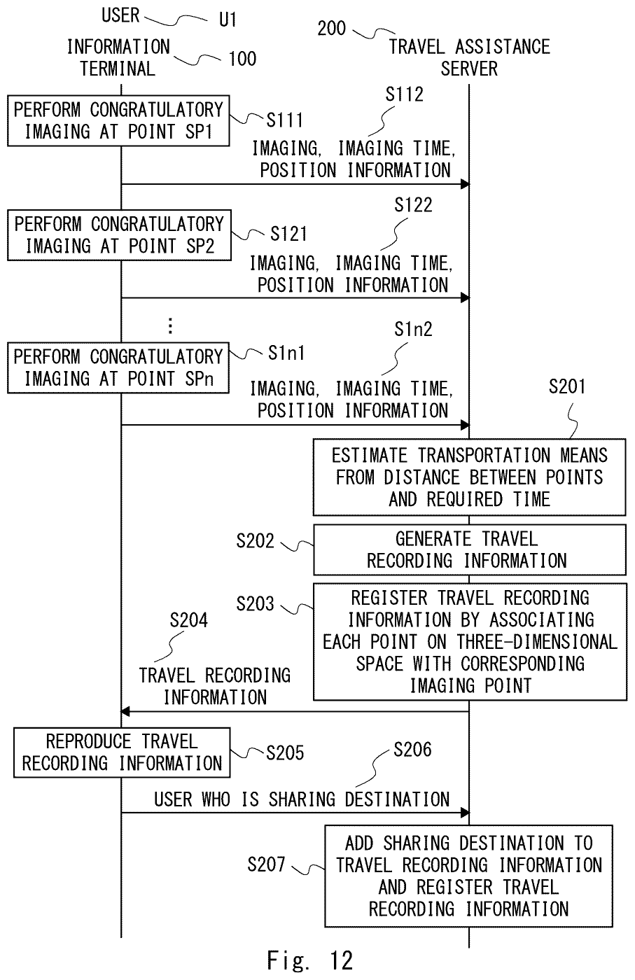

FIG. 12 is a sequence chart showing a flow of travel assistance processing at the time of registration. Here, it is assumed that the user U1 carries the information terminal 100 and makes a tour around (circulates at and visits) the points SP1 to SPn. First, the information terminal 100 performs congratulatory imaging at the point SP1 according to an operation of the user U1 (S111). The information terminal 100 transmits the captured image, an imaging time, and the position information to the travel assistance server 200 via the network N (S112). In this case, the information terminal 100 may perform 3D scanning on the captured image to generate 3D data, and transmit the 3D data to the travel assistance server 200 together with the image and the like. The information terminal 100 may transmit comment information at the point SP1 input from the user U1 to the travel assistance server 200 together with the image and the like.

In this case, the information terminal 100 may transmit a registration request for travel recording information to the travel assistance server 200. The registration request for the travel recording information includes user information of user U1 or terminal information of the information terminal 100 in addition to the image, the imaging time, and the position information. Note that the terminal information enables user information to be specified. The registration request for the travel recording information may include the above 3D data, comment information, and the like. In response to this, the travel assistance server 200 temporarily stores the image, the imaging time, the position information, and the like included in the received registration request in the storage unit 210 in association with the user information. The travel assistance server 200 may perform 3D scanning on the received image to generate 3D data, and temporarily store the 3D data together with the image and the like.

Subsequently, the information terminal 100 performs congratulatory imaging at the point SP2 according to an operation of the user U1 (S121). The information terminal 100 transmits the captured image, the imaging time, and the position information to the travel assistance server 200 via the network N (S122). In response to this, the travel assistance server 200 temporarily stores the image, the imaging time, and the position information included in the received registration request in the storage unit 210 in association with the user information.

Thereafter, similarly, the user U1 moves from the point and captures an image by using the information terminal 100. The information terminal 100 performs congratulatory imaging at the point SPn according to an operation of the user U1 (S1n1). The information terminal 100 transmits the captured image, the imaging time, and the position information to the travel assistance server 200 via the network N (S1n2). In response to this, the travel assistance server 200 temporarily stores the image, the imaging time, and the position information included in the received registration request in the storage unit 210 in association with the user information.

In this case, the information terminal 100 may also transmit a request for starting generation of travel recording information to the travel assistance server 200. The travel assistance server 200 refers to a plurality of sets of images, imaging times, and position information temporarily stored in the storage unit 210. The travel assistance server 200 estimates transportation means from a distance between the points and the required time (S201). As described above, the travel assistance server 200 generates travel recording information (S202). For example, as described above, the travel assistance server 200 may specify the imaging order of each image from the imaging dates and times of the plurality of images, and generate the travel recording information including the imaging order. The travel assistance server 200 may specify point information including the received position information, and generate travel recording information including related information in the point information. The travel assistance server 200 may specify the attribute information 2311 of the user U1 from the received user information, and may cause the specified attribute information 2311 to be included in the travel recording information 251 as the attribute information 2518 to generate the travel recording information 251.

Thereafter, the travel assistance server 200 registers the travel recording information by associating each point on the three-dimensional virtual space with a corresponding imaging point (S203). For example, the travel assistance server 200 specifies point information including the received position information, and causes the specified point information to be included in the imaging point 2513 to generate travel recording information. Thereafter, the travel assistance server 200 transmits the registered travel recording information to the information terminal 100 via the network N (S204).

In response to this, the information terminal 100 reproduces the travel recording information received from the travel assistance server 200 on the screen displaying the three-dimensional virtual space (S205). In response to this, the user U1 may determine a user who is a sharing destination of the travel recording information. The information terminal 100 transmits information of the user who is a sharing destination designated by the user U1 to the travel assistance server 200 via the network N (S206). In response to this, the travel assistance server 200 adds the received user who is a sharing destination to the travel recording information generated in step S202 and registers the travel recording information (S207). Note that, instead of additionally registering the sharing destination, the information terminal 100 may include designation of a user who is a sharing destination in steps S112, S122, . . . , and S1n2 and the request for starting generation of travel recording information.

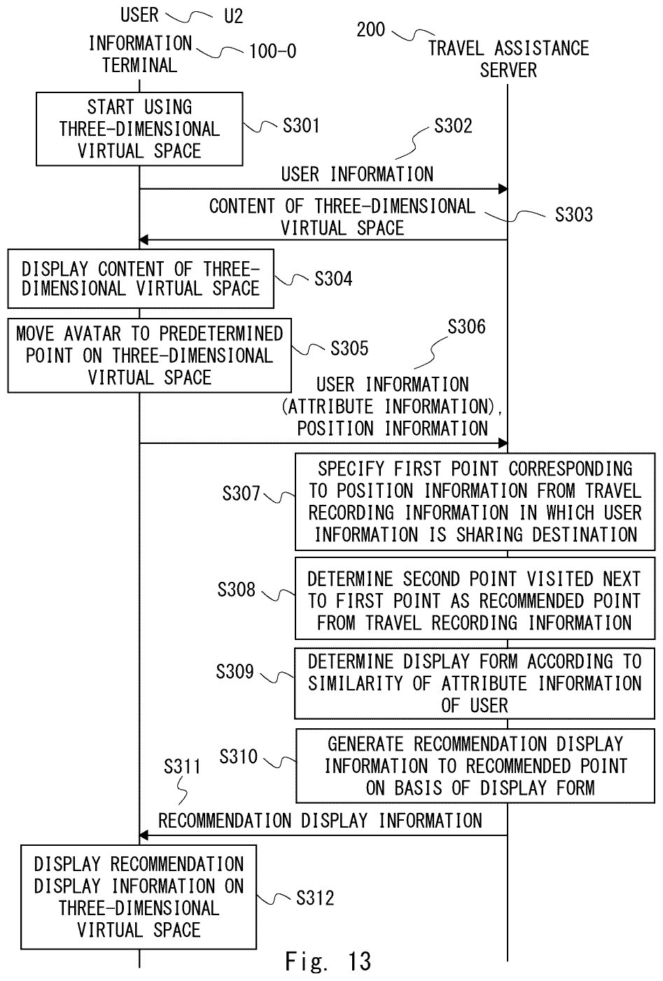

FIG. 13 is a sequence chart showing a flow of travel assistance processing at the time of use. Here, it is assumed that the user U2 uses the three-dimensional virtual space by using the information terminal 100-0. First, the information terminal 100-0 receives the start of use of the three-dimensional virtual space according to an operation of the user U2 (S301). In response to this, the information terminal 100-0 transmits a request for starting use of the three-dimensional virtual space to the travel assistance server 200 via the network N. In this case, the use start request includes user information of the user U2. Note that the use start request may include position information of a start point desired by the user U2.

The information terminal 100-0 receives a content of the three-dimensional virtual space from the travel assistance server 200 (S303). The content includes 3D data of a three-dimensional virtual space at a predetermined point and avatar information of the user U2. The information terminal 100-0 displays the content (3D data and avatar) of the three-dimensional virtual space at the predetermined start point on the screen 123 from the viewpoint of the user U2 (S304).

Subsequently, the information terminal 100-0 moves the avatar from the start point to a predetermined point on the three-dimensional virtual space according to an operation of the user U2 (S305). The information terminal 100-0 transmits the user information of the user U2 and the position information of the predetermined point to the travel assistance server 200 via the network N (S306).

In response to this, the travel assistance server 200 receives the user information (attribute information) of the user U2 and the position information of the predetermined point from the information terminal 100-0. The travel assistance server 200 specifies a first point corresponding to the received position information in the travel recording information (of the user U1) to which the received user information is shared (S307). The travel assistance server 200 determines, as a recommended point, a second point visited next after the first point in the travel recording information (S308). The travel assistance server 200 determines a display form according to a similarity of the attribute information between the users U1 and U2 (S309). The travel assistance server 200 generates recommendation display information at the recommended point on the basis of the determined display form (S310). The travel assistance server 200 transmits the recommendation display information to the information terminal 100-0 via the network N (S311). In response to this, the information terminal 100-0 displays the received recommendation display information on the three-dimensional virtual space on the screen 123 (S312). Steps S305 to S312 are repeatedly executed.

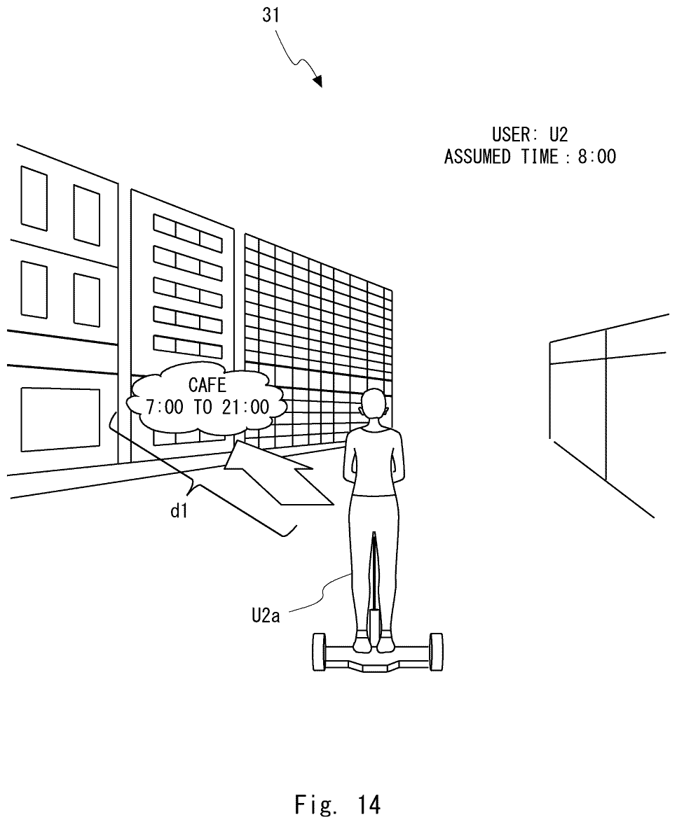

FIG. 14 is a diagram showing a display example of recommendation display information. A three-dimensional virtual space screen 31 is an example displayed on the screen 123 of the information terminal 100-0. It is assumed that the user U2 sets “8:00” as an assumed time on the three-dimensional virtual space screen 31. An avatar U2a and recommendation display information d1 are displayed on the three-dimensional virtual space screen 31. The avatar U2a is an avatar of the user U2. It is assumed that the avatar U2a is moving along a street as a predetermined point (first point) on the three-dimensional virtual space. The recommendation display information d1 includes an arrow from the position of the avatar U2a in the three-dimensional virtual space screen 31 to a building in the upper left direction, and notation of “cafe 7:00 to 21:00”. Here, the recommended point “cafe” indicated by the recommendation display information d1 can be recommended for the following reason. For example, there is a case where a similarity between the preferences (attribute information) of the users U1 and U2 is equal to or more than a threshold, and the user U1 visited the “cafe” in the past. This is a case where the user U1 has evaluated the “cafe” to be more than a threshold. Alternatively, there is a case where the “cafe” includes 8:00, which is the assumed time of the user U2, in the business hours. Alternatively, a price range (cost) of the “cafe” may be within a range of the set budget amount of the user U2. Thus, the user U2 can recognize that the cafe is located in the direction of the arrow from the current position (first point) on the three-dimensional virtual space, and the cafe (second point) is open at the assumed time “8:00”. The user U2 can recognize that the user U2 is recommended to move to the cafe from the recommendation display information d1. Therefore, the user U2 can easily move the avatar U2a from the current position to the cafe on the three-dimensional virtual space, and can virtually experience the inside of the cafe.

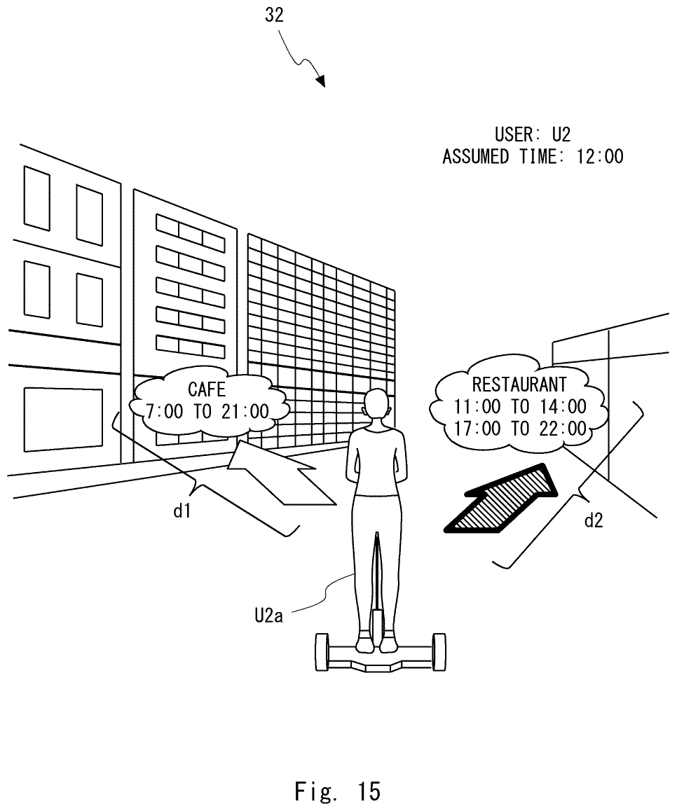

FIG. 15 is a diagram showing a display example of recommendation display information. A three-dimensional virtual space screen 32 is an example displayed on the screen 123 of the information terminal 100-0. It is assumed that the user U2 sets “12:00” as an assumed time on the three-dimensional virtual space screen 32. An avatar U2a, recommendation display information d1, and recommendation display information d2 are displayed on the three-dimensional virtual space screen 32. The recommendation display information d2 includes an arrow from the position of the avatar U2a in the three-dimensional virtual space screen 32 to a building in an upper right direction, and a notation of “restaurant 11:00 to 14:00, 17:00 to 22:00”. Here, the recommended point “restaurant” indicated by the recommendation display information d2 can be recommended for the following reason. For example, there is a case where the “restaurant” includes 12:00, which is the assumed time of the user U2, in the business hours. Alternatively, a price range (cost) of the “restaurant” may be within a range of the set budget amount of the user U2. It is assumed that the recommendation display information d2 has a display form of which the degree of recommendation is higher than that of the recommendation display information d1. The display form indicating the degree of recommendation may be indicated by a color, a size, highlight, or the like of an arrow. For example, in a case where the user U1 has evaluated “restaurant” to be higher than “cafe”, the recommendation display information d2 may have a display form of which the degree of recommendation is higher than that of the recommendation display information d1. Alternatively, in a case where the number of users who have evaluated “restaurant” higher than “cafe” is equal to or larger than a threshold, the recommendation display information d2 may have a display form of which the degree of recommendation is higher than that of the recommendation display information d1. As a result, the user U2 can recognize that there is a restaurant in the direction of the highlighted arrow from the current position (first point) on the three-dimensional virtual space, and the restaurant (second point) is open at the assumed time “12:00”. The user U2 can recognize that the restaurant is strongly recommended rather than the cafe from the recommendation display information d2. Thus, the user U2 can easily move the avatar U2a from the current position to the restaurant on the three-dimensional virtual space, and can virtually experience the inside of the restaurant.

As described above, in the travel assistance system 1000 according to the present disclosure, first, the user U1 records the real experience at each point in the real space through imaging with the information terminal 100, and transmits a captured image and the like to the travel assistance server 200. In response to this, the travel assistance server 200 generates travel recording information of the user U1 and registers the travel recording information in the three-dimensional virtual space. As a result, the user U1 can reproduce the travel recording information on the three-dimensional virtual space via the information terminal 100, and can look back on memories of travel after the travel. Accordingly, the user U1 can share the travel recording information with the user U2 who is a friend. Specifically, the travel assistance server 200 additionally registers the user U2 as a sharing destination in the travel recording information of the user U1 by accepting the designation of the user U2 as the sharing destination by the user U1. That is, the travel assistance server 200 registers the travel recording information in the designated sharing destination to be usable on the three-dimensional virtual space. Thus, the user U2 can virtually experience an unexperienced travel by reproducing the shared travel recording information on the three-dimensional virtual space before the travel, for example. Alternatively, in a case where the above various conditions are satisfied while the user U2 is moving through a predetermined point on the three-dimensional virtual space before a travel, the user U2 can ascertain or virtually experience a recommended point visited by another user in the past. In particular, in a case where a plurality of recommended points are recommended, the user U2 can easily visually ascertain a difference in the degree of recommendation of each recommended point by changing a display form according to the above various conditions. For example, since a recommendation based on travel histories or high evaluations of a plurality of users having high similarity in attribute information can be received even if the user U2 is not a friend, the user U2 can easily ascertain a travel destination matching his/her needs. That is, the accuracy of recommendation is improved. Therefore, the user U2 can efficiently make a travel plan. Such a travel plan increases a probability that the user U2 can experience an enriched travel. That is, the user U2 can easily experience a travel with a high degree of satisfaction. Therefore, the travel assistance system 1000 according to the present disclosure can assist in enriching travel of the user U2.

In the travel assistance system 1000 according to the present disclosure, a plurality of points can be recommended one after another by repeatedly executing steps S305 to S312. That is, unlike the case of simply recommending one place, a tour course may be recommended in the order in which a user actually visited a plurality of points in the past, or the like. Therefore, an increase in the number of tours is promoted, and it becomes easy to ascertain the trend of tourists.

A scheduled traveler can enjoy travel planning and easily consider a travel plan. The scheduled traveler can collect detailed information regarding a site obtained by an actual traveler in real time. A service provider of the travel assistance method according to the present disclosure can create a travel opportunity. The service provider can perform more accurate targeting advertisement according to an attribute of a user (travel recording information of users having close attributes). Therefore, the service provider can promote ticket and tourist content sales.

Since the travel recording information is automatically generated, a traveler can easily leave a detailed travel record (a scene, an impression, a route, and time) as a memory while enjoying a travel. The service provider can expect an increase in the amount of tourist consumption due to an improvement in a tour ratio. The service provider can ascertain a detailed trend of a traveler and can use the trend for marketing.

Automatic generation of travel recording information enables a traveler to re-experience memories of a travel in the virtual space. The traveler shares his/her travel recording information with another person, so that the person sharing the travel recording information can virtually experience a travel in the virtual space before an actual travel. In particular, even in a situation where it is difficult for a person sharing the travel recording information to actually travel, the person can virtually experience a travel in the virtual space due to the shared travel recording information. As a result, it is easy to exchange useful information and make friends between users. A scheduled traveler sharing the travel recording information can easily understand the surroundings, areas, and spots related to a new travel. In addition to creating travel opportunities, the service provider can realize formation of a fan community, creation of a tour package that captures consumer needs, and improvement of sales through purchase in the three-dimensional virtual space. The present example embodiment can achieve various effects similar to those of the first to third example embodiments described above.

### Fifth Example Embodiment

In a fifth example embodiment, a case will be described in which circulation recording information (travel recording information) and circulation schedule information (travel schedule information) are generated on a travel assistance terminal operated by a user.

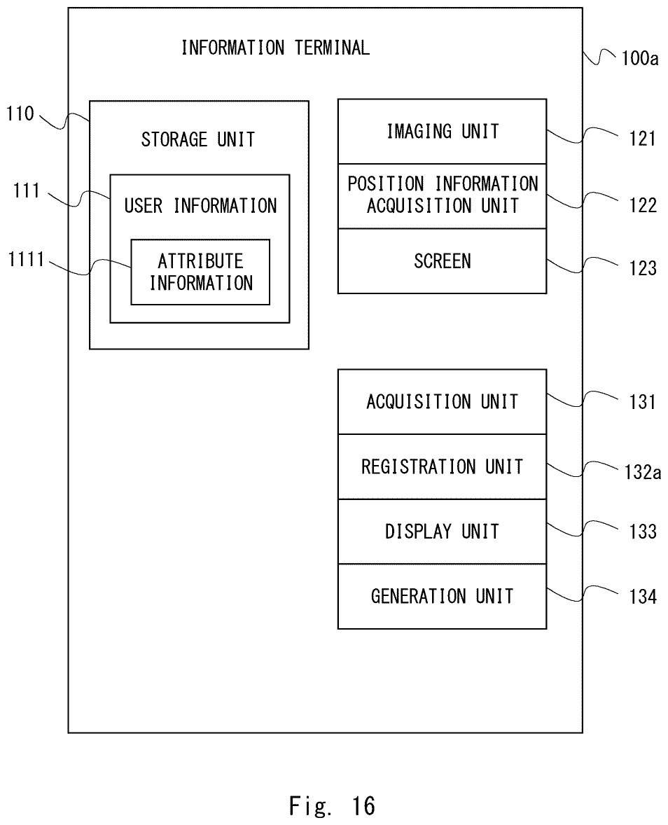

FIG. 16 is a block diagram showing a configuration of an information terminal 100a. The information terminal 100a is different from the information terminal 100 in FIG. 8 described above in that the registration unit 132 is replaced with a registration unit 132a and a generation unit 134 is added. Since other configurations of the information terminal 100a are equivalent to those of the information terminal 100 described above, redundant description will be omitted as appropriate.

The generation unit 134 generates circulation recording information including transportation means between imaging points estimated on the basis of a distance between the imaging points in respective images and a difference between imaging dates and times of the respective images. Therefore, the generation unit 134 may estimate the transportation means between the imaging points on the basis of the distance between the imaging points in the respective images and the difference between the imaging dates and times of the respective image.

The generation unit 134 may generate travel schedule information on the basis of an order of circulating at each point on the three-dimensional virtual space, that is, a circulation route, scheduled visit date and time of each point, and the like.

The registration unit 132a is an example of the registration unit 22 described above. The registration unit 132a registers the travel recording information so that the second user can use the travel recording information by associating each imaging point of the image included in the travel recording information with a corresponding point on the three-dimensional virtual space. Specifically, the registration unit 132a registers the travel recording information by transmitting a registration request including the travel recording information generated by the generation unit 134 to the travel assistance server 200 via the network N. The registration unit 132a may register the travel schedule information by transmitting a registration request including the travel schedule information generated by the generation unit 134 to the travel assistance server 200 via the network N.

Note that the information terminal 100a can be applied to an information terminal operated by both the user U1 who is a traveler and the user U2 who is a scheduled traveler. Therefore, the generation unit 134 may generate second travel recording information (second circulation recording information) including a plurality of images captured by the user U2 at each point on the basis of the imaging order during a travel in the real space. In this case, the registration unit 132a may register the second travel recording information so that a third user can use the second travel recording information by associating each imaging point of the image with a corresponding point on the three-dimensional virtual space. Here, the third user is a user other than the user U2 and includes the user U1.

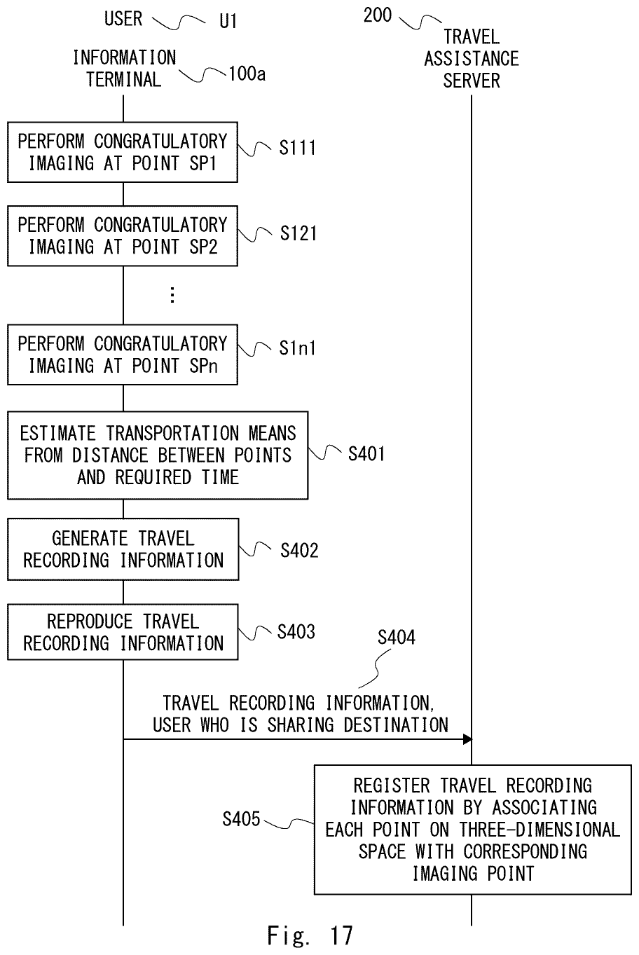

FIG. 17 is a sequence chart showing a flow of travel assistance processing at the time of registration. Hereinafter, a description will focus on differences from FIG. 12 described above, and redundant description will be omitted as appropriate. First, the user U1 carries the information terminal 100a and makes a tour around the points SP1 to SPn. As in steps S111, S121, . . . , and S1n1 described above, the information terminal 100a performs the congratulatory imaging at each of the points SP1 to SPn according to an operation of the user U1. The information terminal 100a need not transmit a captured image or the like to the travel assistance server 200 after the imaging performed at each point.

Thereafter, the information terminal 100a starts generation of travel recording information according to an operation of the user U1. Alternatively, the information terminal 100a may generate and update the travel recording information as needed every time imaging is performed at each point regardless of an operation of the user U1.

For example, in a case where there are two or more points where images have been captured, the information terminal 100a estimates transportation means from a distance between the points and the required time (S401). As described above, the information terminal 100a generates travel recording information (S402). For example, as described above, the information terminal 100a may specify an imaging order of each image from the imaging dates and times of a plurality of images, and generate the travel recording information including the imaging order. The information terminal 100a may generate travel recording information including the attribute information 1111 of the user U2 who is an operator. The information terminal 100a may generate travel recording information including comment information at each point input from the user U2 as related information.

Here, the information terminal 100a may reproduce the travel recording information generated in step S402 on the three-dimensional virtual space (S403). For example, the information terminal 100a and the travel assistance server 200 may perform processes such as steps S301 to S304 in FIG. 13 described above. The information terminal 100a may reproduce the travel recording information by changing (moving the avatar) 3D data of a corresponding point in the three-dimensional virtual space along the imaging order of each point included in the travel recording information and displaying the 3D data on the screen.

Thereafter, the information terminal 100a transmits the travel recording information generated in step S402 and the information of the user who is a sharing destination designated by the user U1 to the travel assistance server 200 via the network N (S404). In response to this, the travel assistance server 200 adds the received user who is a sharing destination to the received travel recording information and updates the travel recording information. Note that, in step S402, the information terminal 100a may generate the travel recording information including the user information of the sharing destination. The travel assistance server 200 registers the travel recording information by associating each point on the three-dimensional virtual space with a corresponding imaging point included in the received travel recording information (S405). In this case, the travel assistance server 200 may additionally register corresponding point information (position information on the three-dimensional virtual space) to each imaging point included in the received travel recording information. Note that, in step S402, the information terminal 100a may add position information on the three-dimensional virtual space corresponding to each imaging point to generate the travel recording information.

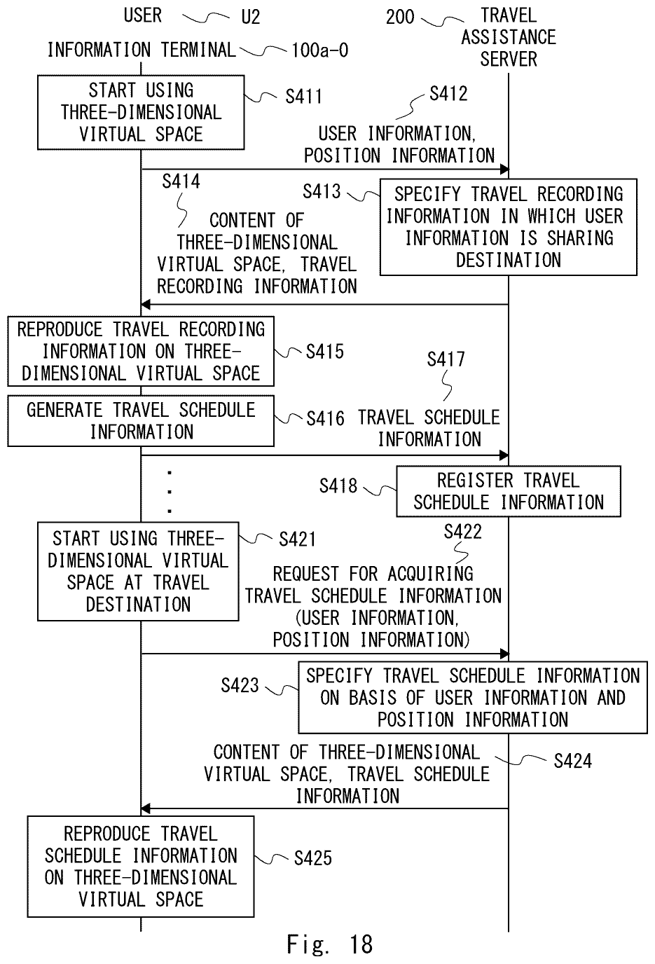

FIG. 18 is a sequence chart showing a flow of travel assistance processing at the time of use. Here, it is assumed that the user U2 uses the three-dimensional virtual space by using an information terminal 100a-0. It is assumed that the information terminal 100a-0 has a function equivalent to that of the information terminal 100a described above.

First, the information terminal 100a-0 receives the start of use of the three-dimensional virtual space according to an operation of the user U2 (S411). In response to this, the information terminal 100a-0 transmits a request for starting use of the three-dimensional virtual space to the travel assistance server 200 via the network N. In this case, the use start request includes user information of the user U2 and position information of the start point.

In response to this, the travel assistance server 200 specifies travel recording information in which the received user information is a sharing destination (S413). The travel assistance server 200 specifies a content of the three-dimensional virtual space corresponding to the received position information of the start point. Thereafter, the travel assistance server 200 transmits the specified content of the three-dimensional virtual space and the travel recording information to the information terminal 100a-0 via the network N (S414).

In response to this, the information terminal 100a-0 reproduces the travel recording information on the three-dimensional virtual space by using the information received from the travel assistance server 200 (S415). As a result, the user U2 moves the avatar or the like via the screen 123 of the information terminal 100a-0, and thus, it becomes easy for the user U2 to consider a group of points around which the user U2 wants to make a tour while virtually experiencing the travel record of the user U1 on the three-dimensional virtual space. The information terminal 100a-0 generates travel schedule information of the user U2 according to an operation of the user U2 (S416). Specifically, as described above, the information terminal 100a-0 generates travel schedule information including the user information of the user U2, the visit order (circulation route) of each point on the three-dimensional virtual space, the scheduled visit date and time of each point, and the like. The information terminal 100a-0 transmits a registration request including the travel schedule information to the travel assistance server 200 via the network N (S417).

In response to this, the travel assistance server 200 registers the received travel recording information of the user U2 in the three-dimensional virtual space information 211 of the storage unit 210 (S418).

Thereafter, the user U2 starts using the three-dimensional virtual space by using the information terminal 100a-0 at the travel destination. First, the information terminal 100a-0 receives the start of use of the three-dimensional virtual space according to an operation of the user U2 (S421). In response to this, the information terminal 100a-0 transmits a request for starting use of the three-dimensional virtual space to the travel assistance server 200 via the network N. In this case, the use start request includes user information of the user U2 and position information of a start point desired by the user U2.

In response to this, the travel assistance server 200 specifies travel schedule information on the basis of the received user information and position information (S423). Specifically, the travel assistance server 200 specifies a content of the three-dimensional virtual space corresponding to the received position information of the start point. The travel assistance server 200 specifies travel schedule information including the received user information. Thereafter, the travel assistance server 200 transmits the specified content of the three-dimensional virtual space and travel schedule information to the information terminal 100a-0 via the network N (S424).

In response to this, the information terminal 100a-0 reproduces the travel schedule information on the three-dimensional virtual space by using the information received from the travel assistance server 200 (S425). As a result, the user U2 can check the itinerary of the day by performing virtual experience on the basis of the travel schedule information on the three-dimensional virtual space before departure on the previous day or the day at a lodging in the travel destination, for example. For example, the user U2 can check a route and transportation means in his/her travel schedule at the travel destination. Therefore, it is possible to assist in enriching travel of the user U2. The present example embodiment can achieve various effects similar to those of the first to fourth example embodiments described above.

### Sixth Example Embodiment

In the sixth example embodiment, when the user U2 holds a camera of the travel assistance terminal over a predetermined point that is a travel destination, recommendation display information for a recommended point based on travel recording information of the user U1 is superimposed and displayed on a captured video of the camera displayed on a screen visually recognized by the user U2. Note that, in the sixth example embodiment, a travel assistance terminal operated by the user U2 will be referred to as an information terminal 100b-0. The information terminal 100b-0 is an example of the travel assistance terminals 1 and 1a described above. The display unit 133 of the information terminal 100b-0 displays recommendation display information based on the current position of the user U2 and the travel recording information of the user U1 to recommend movement to a recommended point on the screen 123 displaying an augmented reality space used by the user U2. Note that the display unit 133 of the information terminal 100b-0 may display the recommendation display information on the screen 123 displaying the augmented reality space by using the travel schedule information of the user U2 instead of the travel recording information of the user U1.

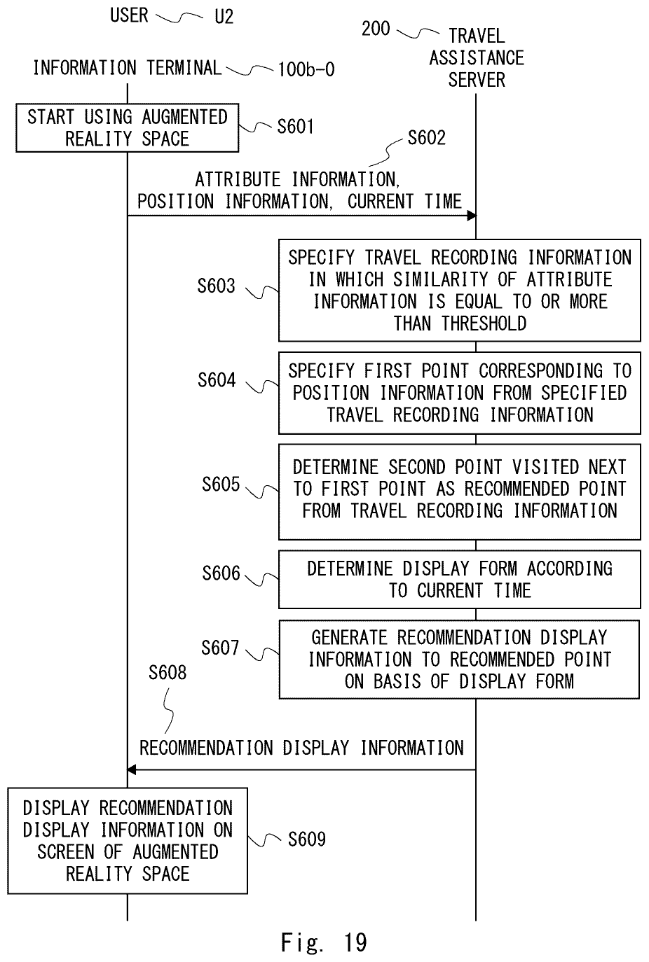

FIG. 19 is a sequence chart showing a flow of travel assistance processing at the time of use. Here, it is assumed that the user U2 uses a function of the augmented reality space by using the information terminal 100b-0. First, the information terminal 100b-0 receives the start of use of the augmented reality space according to an operation of the user U2 (S601). In response to this, the information terminal 100b-0 transmits attribute information and position information of the user U2, and the current time to the travel assistance server 200 via the network N (S602). Note that transmission of the current time may be omitted.

In response to this, the travel assistance server 200 specifies travel recording information including attribute information in which a similarity of the received attribute information is equal to or more than a threshold (S603). Note that, in a case where the travel assistance server 200 has received the user information (identification information or the like) and the position information of the user U2 from the information terminal 100b-0, the travel assistance server may specify travel recording information in which the user information of the user U2 is a sharing destination instead of step S603. The travel assistance server 200 specifies a first point corresponding to the received position information from the specified travel recording information (S604). The travel assistance server 200 determines, as a recommended point, a second point visited next after the first point from the specified travel recording information (S605). In this case, the travel assistance server 200 may determine the recommended point in consideration of the current time. The travel assistance server 200 determines a display form according to the current time (S606). The travel assistance server 200 generates recommendation display information for the recommended point on the basis of the display form (S607). Thereafter, the travel assistance server 200 transmits the recommendation display information to the information terminal 100b-0 via the network N (S608). In response to this, the information terminal 100b-0 displays the received recommendation display information on the screen 123 of the augmented reality space (S609). Specifically, the information terminal 100b-0 superimposes and displays the received recommendation display information on the captured video of the camera displayed on the screen 123. Steps S602 to S609 are repeatedly executed.

As described above, according to the sixth example embodiment, the user U2 holds the camera of the user U2's travel assistance terminal over a predetermined point that is a travel destination, so that the user U2 can receive recommendation for movement from the current point to a recommended point on the basis of travel recording information of a travel experienced person. Therefore, the user U2 can easily make a tour based on travel histories of various travel experienced people in the corresponding area without making a detailed travel plan in advance. In particular, since a point that is the next destination is recommended on the basis of travel recording information of a user (travel experienced person) having attribute information highly similar to the attribute information of the user U2, there is a high possibility that the point is close to the need of the user U2. Therefore, it is possible to assist in enriching travel of the user U2. In particular, since the user U2 can receive a recommendation based on the current time at the site that is a travel destination, the convenience for the user U2 is high. The present example embodiment can achieve various effects similar to those of the first to fifth example embodiments described above.

### Other Example Embodiment

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

A (The) program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Some or all of the above-described example embodiments may be described as in the following Supplementary Notes, but are not limited to the following Supplementary Notes.

### (Supplementary Note A1) (Terminal on Second User Side)

A travel assistance terminal including:
acquisition means for acquiring information regarding a recommended point determined based on circulation recording information including a plurality of images captured at each point by a first user and generated on the basis of an imaging order, the circulation recording information being information in which each imaging point of the images is associated with a corresponding point on a three-dimensional virtual space, and position information of a second user; and
display means for displaying a recommendation to move to the recommended point on a screen displayed from a viewpoint of the second user. (Supplementary Note A2)

The travel assistance terminal according to Supplementary Note A1, in which
the display means displays recommendation display information for recommending movement to the recommended point on the screen.

### Supplementary Note A3

The travel assistance terminal according to Supplementary Note A2, in which
the display means displays the recommendation display information by using a second point visited next after the first point by the first user as the recommended point on the basis of the imaging order in the circulation recording information when the second user visits a first point included in the circulation recording information.

### Supplementary Note A4

The travel assistance terminal according to Supplementary Note A2, in which
the circulation recording information includes an imaging time of each of the images, and
the display means displays the recommendation display information by using a determined point from the circulation recording information based on the imaging time and time information when the second user visits a first point in the circulation recording information as the recommended point.

### Supplementary Note A5

The travel assistance terminal according to any one of Supplementary Notes A2 to A4, in which
the circulation recording information includes first attribute information of the first user, and
the display means displays the recommendation display information based on a similarity between the first attribute information and second attribute information of the second user and based on the circulation recording information.

### Supplementary Note A6

The travel assistance terminal according to Supplementary Note A5, in which
the display means displays the recommendation display information at a plurality of recommended points in different display forms according to a similarity between each of pieces of the first attribute information included in the circulation recording information of a plurality of the first users and the second attribute information.

### Supplementary Note A7

The travel assistance terminal according to any one of Supplementary Notes A2 to A5, in which
the display means displays the recommendation display information at a plurality of recommended points based on the circulation recording information of a plurality of the first users on the screen.

### Supplementary Note A8

The travel assistance terminal according to Supplementary Note A7, in which
the display means displays the recommendation display information at the plurality of respective recommended points in different display forms according to an evaluation of the first user who has visited each of the plurality of recommended points.

### Supplementary Note A9

The travel assistance terminal according to Supplementary Note A7 or A8, in which
the display means displays the recommendation display information at the plurality of respective recommended points in different display forms according to a cost associated with each of the recommended points.

### Supplementary Note A10

The travel assistance terminal according to any one of Supplementary Notes A1 to A9, in which
the display means displays a recommendation to move to the recommended point on the screen displaying the three-dimensional virtual space used by the second.

### Supplementary Note A11

The travel assistance terminal according to any one of Supplementary Notes A1 to A9, in which
the display means displays a recommendation to move to the recommended point based on a current position of the second user and the circulation recording on the screen displaying an augmented reality space used by the second.

### Supplementary Note A12

The travel assistance terminal according to any one of Supplementary Notes A1 to A11, further including:
generation means for generating the circulation recording information including transportation means between imaging points estimated on the basis of a distance between the imaging points of the respective images and a difference between imaging dates and times of the respective images.

### Supplementary Note A13

The travel assistance terminal according to any one of Supplementary Notes A1 to A12, further including:
acquisition means for acquiring a plurality of images captured at each point by the second user; and
registration means for registering second circulation recording information including the plurality of images and generated on the basis of an imaging order by associating each imaging point of the images with a corresponding point on the three-dimensional virtual space such that the second circulation recording information is available to a third user.

### (Supplementary Note B1) (Server)

A travel assistance apparatus including:
generation means for generating circulation recording information based on an imaging order including a plurality of images captured at each point by a first user; and
registration means for registering the circulation recording information such that the circulation recording information is available to a second user by associating each imaging point of the images included in the circulation recording information with a corresponding point on a three-dimensional virtual space.

### Supplementary Note B2

The travel assistance apparatus according to Supplementary Note B1, further including:
display means for displaying recommendation display information for recommending movement to a recommended point based on the circulation recording information on a screen displayed from a viewpoint of the second user.

### Supplementary Note B3

The travel assistance apparatus according to Supplementary Note B2, in which
the display means displays the recommendation display information by using a second point visited next after the first point by the first user as the recommended point on the basis of the imaging order in the circulation recording information when the second user visits a first point included in the circulation recording information.

### Supplementary Note B4

The travel assistance apparatus according to Supplementary Note B2, in which
the generation means generates the circulation recording information including an imaging time of each of the plurality of images, and
the display means determines the recommended point in the circulation recording information based on the imaging time and time information when the second user visits a first point in the circulation recording information, and displays the recommendation display information at the determined recommended point.

### Supplementary Note B5

The travel assistance apparatus according to any one of Supplementary Notes B2 to B4, in which
the generation means generates the circulation recording information including first attribute information of the first user, and
the display means displays the recommendation display information based on a similarity between the first attribute information and second attribute information of the second user and based on the circulation recording information.

### Supplementary Note B6

The travel assistance apparatus according to Supplementary Note B5, in which
the display means displays the recommendation display information at a plurality of recommended points in different display forms according to a similarity between each of pieces of the first attribute information of a plurality of the first users included in the circulation recording information and the second attribute information.

### Supplementary Note B7

The travel assistance apparatus according to any one of Supplementary Notes B2 to B5, in which
the display means displays the recommendation display information at a plurality of recommended points based on the circulation recording information of a plurality of the first users on the screen.

### Supplementary Note B8

The travel assistance apparatus according to Supplementary Note B7, in which
the display means displays the recommendation display information at the plurality of respective recommended points in different display forms according to an evaluation of the first user who has visited each of the plurality of recommended points.

### Supplementary Note B9

The travel assistance apparatus according to Supplementary Note B7 or B8, in which
the display means displays the recommendation display information at the plurality of respective recommended points in different display forms according to a cost associated with each of the recommended points.

### Supplementary Note B10

The travel assistance apparatus according to any one of Supplementary Notes B2 to B9, in which
the registration means registers the circulation recording information so that the circulation recording information is available to the second user on the three-dimensional virtual space, and
the display means displays the recommendation display information at the recommended point on the screen displaying the three-dimensional virtual space used by the second user.

### Supplementary Note B11

The travel assistance apparatus according to any one of Supplementary Notes B2 to B9, in which
the display means displays the recommendation display information at the recommended point on the basis of a current position of the second user and the circulation recording information on the screen displaying an augmented reality space used by the second user.

### Supplementary Note B12

The travel assistance apparatus according to any one of Supplementary Notes B1 to B11, in which
the generation means generates the circulation recording information including transportation means between imaging points estimated on the basis of a distance between the imaging points of the respective images and a difference between imaging dates and times of the respective images.

### (Supplementary Note C1) (Terminal on First User Side)

A travel assistance terminal including:
acquisition means for acquiring a plurality of images captured at each point by a first user; and
registration means for registering circulation recording information including the plurality of images and generated on the basis of an imaging order such that the circulation recording information is available to a second user by associating each imaging point of the images with a corresponding point on a three-dimensional virtual space.

### Supplementary Note C2

The travel assistance terminal according to Supplementary Note C1, in which
the circulation recording information includes first attribute information of the first user, and
the registration means registers the circulation recording information to display recommendation display information for recommending movement to a recommended point based on a similarity between the first attribute information and second attribute information of the second user and based on the circulation recording information.

### Supplementary Note C3

The travel assistance terminal according to Supplementary Note C1 or C2, in which
the registration means registers the circulation recording information so that the circulation recording information is available to the second user on the three-dimensional virtual space.

### Supplementary Note C4

The travel assistance terminal according to any one of Supplementary Notes C1 to C3, in which
the circulation recording information includes transportation means estimated on the basis of a distance between imaging points of the respective images and a difference between imaging dates and times of the respective images.

### Supplementary Note C5

The travel assistance terminal according to any one of Supplementary Notes C1 to C4, in which
the acquisition means acquires information regarding a recommended point determined based on second circulation recording information including a plurality of images captured at each point by a third user and generated on the basis of an imaging order, the second circulation recording information being information in which each imaging point of the images is associated with a corresponding point on the three-dimensional virtual space, and position information of the first user, and
the travel assistance terminal further comprises first display means for displaying a recommendation to move to the recommended point on a screen displayed from a viewpoint of the first user.

### Supplementary Note C6

The travel assistance terminal according to any one of Supplementary Notes C1 to C5, further including:
second display means for displaying information based on the circulation recording information at an imaging point included in the circulation recording information on a screen displaying the three-dimensional virtual space from a viewpoint of the first user.

### Supplementary Note C7

The travel assistance terminal according to any one of Supplementary Notes C1 to C6, further including:
generation means for generating the circulation recording information including transportation means between imaging points estimated on the basis of a distance between the imaging points of the respective images and a difference between imaging dates and times of the respective images.

### Supplementary Note D1

A travel assistance system including:
a first travel assistance terminal;
a second travel assistance terminal; and
a travel assistance apparatus, in which
the first travel assistance terminal transmits, to the travel assistance apparatus, a plurality of images captured by a first user at each point, and
the travel assistance apparatus
generates circulation recording information based on an imaging order including the plurality of images received from the first travel assistance terminal, and
registers the circulation recording information such that the circulation recording information is available to a second user via the second travel assistance terminal by associating each imaging point of the images included in the circulation recording information with each point on a three-dimensional virtual space.

### Supplementary Note D2

The travel assistance system according to Supplementary Note D1, in which
the travel assistance apparatus determines a recommended point on the basis of the circulation recording information and position information of the second user, and
the second travel assistance terminal
acquires information regarding the determined recommended point from the travel assistance apparatus, and
displays a recommendation to move to the recommended point on a screen displayed from a viewpoint of the second user.

### (Supplementary Note E1) (Processing Method of Terminal on Second User Side)

A travel assistance method of causing a computer to execute:
acquiring information regarding a recommended point determined based on circulation recording information including a plurality of images captured at each point by a first user and generated on the basis of an imaging order, the circulation recording information being information in which each imaging point of the images is associated with a corresponding point on a three-dimensional virtual space, and position information of a second user; and
displaying a recommendation to move to the recommended point on a screen displayed from a viewpoint of the second user.

### (Supplementary Note F1) (Processing Method of Server)

A travel assistance method of causing a computer to execute:
generating circulation recording information based on an imaging order including a plurality of images captured at each point by a first user; and
registering the circulation recording information such that the circulation recording information is available to a second user by associating each imaging point of the images included in the circulation recording information with each point on a three-dimensional virtual space.

### (Supplementary Note G1) (Processing Method of Terminal on First User Side)

A travel assistance method of causing a computer to execute:
acquiring a plurality of images captured at each point by a first user; and
registering circulation recording information including the plurality of images and generated on the basis of an imaging order such that the circulation recording information is available to a second user by associating each imaging point of the images with each point on a three-dimensional virtual space.

### (Supplementary Note H1) (Program of Terminal on Second User Side)

A travel assistance program for causing a computer to execute:
an acquisition process of acquiring information regarding a recommended point determined based on circulation recording information including a plurality of images captured at each point by a first user and generated on the basis of an imaging order, the circulation recording information being information in which each imaging point of the images is associated with a corresponding point on a three-dimensional virtual space, and position information of a second user; and
a recommendation display process of displaying a recommendation to move to the recommended point on a screen displayed from a viewpoint of the second user.

### (Supplementary Note I1) (Program of Server)

A travel assistance program for causing a computer to execute:
a generation process of generating circulation recording information based on an imaging order including a plurality of images captured at each point by a first user; and
a registration process of registering the circulation recording information such that the circulation recording information is available to a second user by associating each imaging point of the images included in the circulation recording information with each point on a three-dimensional virtual space.

### (Supplementary Note J1) (Program of Terminal on First User Side)

A travel assistance program for causing a computer to execute:
an acquisition process of acquiring a plurality of images captured at each point by a first user; and
a registration process of registering circulation recording information including the plurality of images and generated on the basis of an imaging order such that the circulation recording information is available to a second user by associating each imaging point of the images with each point on a three-dimensional virtual space.

Some or all of the elements (for example, configurations and functions) disclosed in Supplementary Notes A2 to A13 dependent on Supplementary Note A1 {e.g. a terminal} can also be dependent on Supplementary Note B1 {e.g. an apparatus}, Supplementary Note C1 {e.g. a terminal}, Supplementary Note D1 {e.g. a system}, Supplementary Notes E1, F1, and G1 {e.g. methods}, and Supplementary Notes H1, I1, and J1 {e.g. programs} by the same dependency relationship as Supplementary Notes A2 to A13. Some or all of the elements (for example, configurations and functions) disclosed in Supplementary Notes B2 to B12 dependent on Supplementary Note B1 {e.g. an apparatus} can also be dependent on Supplementary Notes A1 {e.g. a terminal}, Supplementary Note C1 {e.g. a terminal}, Supplementary Note D1 {e.g. a system}, Supplementary Notes E1, F1, and G1 {e.g. methods}, and Supplementary Notes H1, I1, and J1 {e.g. programs} by the same dependency relationship as Supplementary Notes B2 to B12. Some or all of the elements (for example, configurations and functions) disclosed in the Supplementary Notes C2 to C7 dependent on the Supplementary Note C1 {e.g. a terminal} can also be dependent on the Supplementary Notes A1 {e.g. a terminal}, B1 {e.g. an apparatus}, D1 {e.g. a system}, Supplementary Notes E1, F1, and G1 {e.g. methods}, and Supplementary Notes H1, I1, and J1 {e.g. programs} by the same dependency relationship as the Supplementary Notes C2 to C7. Some or all of the elements disclosed in any Supplementary Notes may be applied to various types of hardware, software, recording means for recording software, systems, and methods.

What is claimed is:

1. A travel assistance terminal comprising:
at least one memory storing instructions; and
at least one processor configured to execute the instructions to:
acquire information regarding a recommended point determined based on circulation recording information including a plurality of images captured at each point by a first user and generated on the basis of an imaging order, the circulation recording information being information in which each imaging point of the images is associated with a corresponding point on a three-dimensional virtual space, and position information of a second user; and
display a recommendation to move to the recommended point on a screen displayed from a viewpoint of the second user.

2. The travel assistance terminal according to claim 1, wherein the at least one processor is further configured to execute the instructions to display recommendation display information for recommending movement to the recommended point on the screen.

3. The travel assistance terminal according to claim 2, wherein the at least one processor is further configured to execute the instructions to display the recommendation display information by using a second point visited next after the first point by the first user as the recommended point on the basis of the imaging order in the circulation recording information when the second user visits a first point included in the circulation recording information.

4. The travel assistance terminal according to claim 2, wherein
the circulation recording information includes an imaging time of each of the images, and
wherein the at least one processor is further configured to execute the instructions to display the recommendation display information by using a determined point from the circulation recording information based on the imaging time and time information when the second user visits a first point in the circulation recording information as the recommended point.

5. The travel assistance terminal according to claim 2, wherein
the circulation recording information includes first attribute information of the first user, and
wherein the at least one processor is further configured to execute the instructions to display the recommendation display information based on a similarity between the first attribute information and second attribute information of the second user and based on the circulation recording information.

6. The travel assistance terminal according to claim 5, wherein the at least one processor is further configured to execute the instructions to display the recommendation display information at a plurality of recommended points in different display forms according to a similarity between each of pieces of the first attribute information included in the circulation recording information of a plurality of the first users and the second attribute information.

7. The travel assistance terminal according to claim 2, wherein the at least one processor is further configured to execute the instructions to display the recommendation display information at a plurality of recommended points based on the circulation recording information of a plurality of the first users on the screen.

8. The travel assistance terminal according to claim 7, wherein the at least one processor is further configured to execute the instructions to display the recommendation display information at the plurality of respective recommended points in different display forms according to an evaluation of the first user who has visited each of the plurality of recommended points.

9. The travel assistance terminal according to claim 7, wherein the at least one processor is further configured to execute the instructions to display the recommendation display information at the plurality of respective recommended points in different display forms according to a cost associated with each of the recommended points.

10. The travel assistance terminal according to claim 1, wherein the at least one processor is further configured to execute the instructions to display a recommendation to move to the recommended point on the screen displaying the three-dimensional virtual space used by the second.

11. The travel assistance terminal according to claim 1, wherein the at least one processor is further configured to execute the instructions to display a recommendation to move to the recommended point based on a current position of the second user and the circulation recording on the screen displaying an augmented reality space used by the second.

12. The travel assistance terminal according to claim 1, wherein the at least one processor is further configured to execute the instructions to generate the circulation recording information including transportation means between imaging points estimated on the basis of a distance between the imaging points of the respective images and a difference between imaging dates and times of the respective images.

13. The travel assistance terminal according to claim 1, wherein the at least one processor is further configured to execute the instructions to;
acquire a plurality of images captured at each point by the second user; and
register second circulation recording information including the plurality of images and generated on the basis of an imaging order by associating each imaging point of the images with a corresponding point on the three-dimensional virtual space such that the second circulation recording information is available to a third user.

14. A travel assistance terminal comprising:
at least one memory storing instructions; and
at least one processor configured to execute the instructions to:
acquire a plurality of images captured at each point by a first user; and
register circulation recording information including the plurality of images and generated on the basis of an imaging order such that the circulation recording information is available to a second user by associating each imaging point of the images with a corresponding point on a three-dimensional virtual space.

15. The travel assistance terminal according to claim 14, wherein
the circulation recording information includes first attribute information of the first user, and
wherein the at least one processor is further configured to execute the instructions to register the circulation recording information to display recommendation display information for recommending movement to a recommended point based on a similarity between the first attribute information and second attribute information of the second user and based on the circulation recording information.

16. The travel assistance terminal according to claim 14, wherein the at least one processor is further configured to execute the instructions to register the circulation recording information so that the circulation recording information is available to the second user on the three-dimensional virtual space.

17. The travel assistance terminal according to claim 14, wherein the circulation recording information includes transportation means estimated on the basis of a distance between imaging points of the respective images and a difference between imaging dates and times of the respective images.

18. The travel assistance terminal according to claim 14, wherein the at least one processor is further configured to execute the instructions to;
acquire information regarding a recommended point determined based on second circulation recording information including a plurality of images captured at each point by a third user and generated on the basis of an imaging order, the second circulation recording information being information in which each imaging point of the images is associated with a corresponding point on the three-dimensional virtual space, and position information of the first user, and
display, as a first display step, a recommendation to move to the recommended point on a screen displayed from a viewpoint of the first user.

19. The travel assistance terminal according to claim 14, wherein the at least one processor is further configured to execute the instructions to display, as a second display step, information based on the circulation recording information at an imaging point included in the circulation recording information on a screen displaying the three-dimensional virtual space from a viewpoint of the first user.

20. The travel assistance terminal according to claim 14, wherein the at least one processor is further configured to execute the instructions to generate the circulation recording information including transportation means between imaging points estimated on the basis of a distance between the imaging points of the respective images and a difference between imaging dates and times of the respective images.
